(19) United States
(12) Patent Application Publication
(10) Pub. No.: US 2010/0208885 A1
(43) Pub. Date: Aug. 19, 2010

(54) CRYPTOGRAPHIC PROCESSING AND PROCESSORS

(76) Inventor: Julian Philip Murphy, Hebburn (GB)

Correspondence Address: GREENBERG TRAURIG, LLP, MET LIFE BUILDING, 200 PARK AVENUE, NEW YORK, NY, 10166, US

(21) Appl. No.: 12/681,302

(22) PCT Filed: Oct. 3, 2008
(86) PCT No.: PCT/GB08/03349

§ 371 Date: Apr. 1, 2010

(30) Foreign Application Priority Data
Oct. 4, 2007 (GB) 0719455.8

(51) Int. Cl. H04L 9/28

(52) U.S. Cl. 380/28

(57) ABSTRACT

A method of performing a cryptographic process on data, the cryptographic process treating a quantity of the data as an element of a Galois field GF(λ^{k}), where k=rs, the method comprising: isomorphically mapping the element of the Galois field GF(λ^{k}) to an s-tuple of elements of a Galois field GF(λ′); and representing and processing each of the elements of the s-tuple of elements of the Galois field GF(λ′) in the form of one or more respective n-of-m codewords, where an n-of-m codeword comprises n 1-bits and m-n 0-bits, where m and n are predetermined positive integers and n is less than m.

### FIELD OF THE INVENTION

The present invention relates to a method of performing a cryptographic process and an apparatus for performing a cryptographic process.

### BACKGROUND OF THE INVENTION

Many cryptographic algorithms are known and they have a variety of uses, such as for data encryption/decryption, key-exchange, digital signatures, generating secure hash values, authentication, etc. A given cryptographic algorithm may be considered to be secure from a mathematical viewpoint. For example, an encryption algorithm using a secret key may be able to withstand mathematical cryptanalysis attacks that try to deduce the secret key by statistically analysing the ciphertext that is produced when differing plaintexts are input to the encryption algorithm.

However, regardless of the mathematical security of a cryptographic algorithm, a hardware implementation of the cryptographic algorithm (such as in an integrated circuit) may itself introduce weaknesses that can leak sensitive information correlated to the secret key(s) being used, through side-channels. Once the secret key(s) have been deduced from the side-channel information, the security is considered to have been breached.

For example, a conditional operation/branch within the hardware implementation of a cryptographic algorithm can result in different power usage depending on which branch is chosen. If this difference in power consumption can be measured, then information regarding the plaintext, ciphertext, keys, or intermediate values can be deduced.

Similarly, processing a 0-bit usually involves using less power than processing a 1-bit. If this difference in power consumption can be measured, then it can be used to reveal whether a 0-bit or a 1-bit is being processed at a particular stage in the cryptographic algorithm.

Other features of a hardware implementation of a cryptographic algorithm are known to result in different power consumption under different input/output conditions.

Simple power analysis and differential power analysis are well-known attacks that can be used against cryptographic systems (see, for example, “Differential Power Analysis”, Paul Kocher et al, Cryptography Research, Inc.). These attacks are based on analysing the hardware implementation of a cryptographic algorithm rather than attacking the underlying cryptographic algorithm itself (such as its mathematical principles and structure). In particular, these attacks involve measuring and analysing the power consumption of a hardware implementation of a cryptographic algorithm which, as discussed above, can vary depending on the data being processed and the various branching that is performed.

These power analysis attacks shall not be described in detail herein. However, in summary, simple power analysis involves directly interpreting power consumption measurements collected during the operation of the hardware implementation of the cryptographic algorithm. Differential power analysis involves testing a hypothesis (such as a hypothesis that a particular bit of a secret key is a 1) by statistically analysing the power consumption of the hardware implementation across many different input data. These attacks may involve detecting electromagnetic emissions, measuring power consumption and measuring timing variations.

Some countermeasures against such power analysis attacks are known, for example implementing the cryptographic algorithm by using a hardware structure/data-flow that tries to avoid conditional branching. However, for many cryptographic algorithms this is not always straightforward and, if such countermeasures can actually be implemented for a particular cryptographic algorithm, the implementation invariably requires significantly more hardware and actually runs more slowly than a conventional implementation.

Another kind of attack that may be performed by an attacker is a fault-injection attack, in which the attacker causes errors to be introduced into the cryptographic system in order to cause unintended behaviour which the attacker hopes can be analysed to hopefully compromise the security of the system.

Unwanted errors can also be introduced under normal operating conditions. For example, radiation can cause faults in space/satellite communications or in devices operating in such environments.

Cryptographic algorithms are being used more and more. For example, smart cards, integrated-circuit cards/devices and other embedded security devices are becoming prevalent, with many personal and business transactions being performed on sensitive data, such as financial data, medical data, security access data, etc. There is therefore a need for hardware implementations of cryptographic algorithms that have improved countermeasures against the various attacks (e.g. power analysis attacks and fault-injection attacks).

### SUMMARY OF THE INVENTION

According to an aspect of the invention, there is provided a method of performing a cryptographic process on data, the cryptographic process treating a quantity of the data as an element of a Galois field GF(λ^{k}), where k=rs, the method comprising: isomorphically mapping the element of the Galois field GF(λ^{k}) to an s-tuple of elements of a Galois field GF(λ^{r}); and representing and processing each of the elements of the s-tuple of elements of the Galois field GF(λ^{r}) in the form of one or more respective n-of-m codewords, where an n-of-m codeword comprises n 1-bits and m-n 0-bits, where m and n are predetermined positive integers and n is less than m. Here, r and s are integers greater than 1. The logic used to implement such a method may be referred to as “Galois Encoded Logic” or “GEL”.

By processing the data as n-of-m codewords, the number of 1-bits used to represent the data is a predetermined value independent of the actual values that the data assumes. Maintaining the n-of-m representation of the data throughout the cryptographic processing (i.e. using n-of-m codewords throughout the entire data-path for the data being processed) helps reduce the likelihood of a successful power analysis attack being launched against the cryptographic processing.

Additionally, the processing of the data as s-tuples of elements of the Galois subfield GF(λ^{r}), when the cryptographic algorithm treats a quantity of data as an element of the composite Galois field GF(λ^{k}), enables easier implementation of the cryptographic processing, a reduced integrated circuit implementation area and a reduced power consumption for hardware devices.

Embodiments of the invention may comprise isomorphically mapping the processed s-tuple of elements of the Galois field GF(λ^{r}) to an element of the Galois field GF(λ^{k}).

The value of λ (the characteristic of the Galois field GF(λ^{r})) may assume any prime value according to the particular cryptographic processing to be performed, such as 2 or 3. When λ=2 then in some embodiments of the invention, k=8, s=4 and r=2. In this way, a byte of data treated as an element of GF(2⁸) may be processed as a 4-tuple of elements of GF(2²). Each element of GF(2²) may be represented, for example, as a corresponding 1-of-4 codeword, so that the byte of data is represented as a 4-tuple of 1-of-4 codewords.

In embodiments of the invention, the cryptographic process may involve performing a Galois field GF(λ^{k}) operation involving an element of the Galois field GF(λ^{k}) corresponding to at least a part of the data, the method then comprising: performing the Galois field GF(λ^{k}) operation by performing one or more Galois field GF(λ^{r}) operations involving the s-tuple of elements of the Galois field GF(λ^{k}) corresponding to the element of the Galois field GF(e) corresponding to the at least a part of the data. The Galois field GF(λ^{k}) operation may comprises one or more of: GF(λ^{k}) addition, GF(λ^{k}) multiplication, GF(λ^{k}) subtraction, GF(λ^{k}) division, GF(λ^{k}) exponentiation, GF(λ^{k}) inversion, GF(λ^{k}) logarithm, and a GF(λ^{k}) logical operation. The Galois field GF(λ^{r}) operation comprises one or more of: GF(λ^{r}) addition, GF(λ^{r}) multiplication, GF(λ^{r}) subtraction, GF(λ^{r}) division, GF(λ^{r}) exponentiation, GF(λ^{r}) inversion, GF(λ^{r}) logarithm, and a GF(λ^{r}) logical operation.

As many applications involve providing data in binary format (as opposed to n-of-m formatted data), embodiments of the invention may comprise receiving input data in a binary format; and converting the input data from the binary format to one or more n-of-m codewords for processing. Additionally, as many applications involve outputting data in binary format (as opposed to n-of-m formatted data), embodiments of the invention may comprise converting the processed data represented as n-of-m codewords to a binary format; and outputting the processed binary format data.

In embodiments of the invention, processing a first n-of-m codeword and then processing a subsequent second n-of-m codeword may comprise using a predetermined data value between the first n-of-m codeword and the second n-of-m codeword. This predetermined data value may comprise m 0-bits or m 1-bits. In this way, transitions between successive n-of-m codewords can pass through a predetermined state, so that the number of wires activated and deactivated between successive n-of-m codewords can be set to a predetermined value. This provides a further countermeasure against power analysis attacks.

In embodiments of the invention processing an n-of-m codeword may comprise converting the n-of-m codeword to one or more p-of-q codewords, where the pair (p,q) is different from the pair (n,m); processing the one or more p-of-q codewords; and converting the processed one or more p-of-q codewords to an n-of-m codeword. This is particularly useful when the processing performed using the p-of-q codewords is more easily implemented or involves a reduced amount of hardware than the processing performed using the n-of-m codewords. For example, when p=1 and q=2, the 1-of-2 codewords used can represent individual bits of the data, so that operations on a single bit of the data may be performed.

In preferred embodiments of the invention, n=1 and m=4. These values of n and m provide a good balance between the degree to which data is expanded and the amount of power consumed by hardware embodiments of the invention.

The cryptographic process may be any cryptographic process/security process, such as an encryption process; a decryption process; a hashing process; a digital signature process; a key-exchange process; an authentication process; or a message-authentication-code. This process may be based on symmetric encryption/decryption (such as DES, triple DES, AES, Camellia, IDEA, SEAL and RC4), asymmetric/public-key encryption/decryption (such as RSA, EIGamal and elliptic curve cryptography), digital signatures using DSA, EIGamal and RSA, and the Diffe-Hellman key agreement protocols.

Some embodiments of the invention may comprise detecting that an error has been introduced into the codewords being processed by checking that a data word being processed is represented as a n-of-m codeword. For example, if the processing is being performed using 2-of-4 codewords and a codeword has more than two 1-bit, then it cannot be a 2-of-4 codeword, so an error has been detected in the data being processed. This can be used as a countermeasure against fault-injection attacks. The use of the n-of-m format inherently allows such errors to be detected in an manner requiring a low implementation cost.

According to another aspect of the invention, there is provided an apparatus for performing a cryptographic process on data, the cryptographic process treating a quantity of the data as an element of a Galois field GF(λ^{k}), where k=rs, the apparatus comprising a logic processor arranged to: isomorphically map the element of the Galois field GF(λ^{k}) to an s-tuple of elements of a Galois field GF(λ^{r}) and represent and process each of the elements of the s-tuple of elements of the Galois field GF(λ^{r}) in the form of one or more respective n-of-m codewords, where an n-of-m codeword comprises n 1-bits and m-n 0-bits, where m and n are predetermined positive integers and n is less than m.

The apparatus may comprise one or more logic structures arranged together to perform the cryptographic process, where at least one of the logic structures is a power balanced logic structure. A power balanced logic structure is a logic circuit that comprises logic gates arranged such that the logic circuit consumes substantially the same amount of power for all possible combinations of valid inputs to the logic circuit. In this way, the power consumed by the apparatus may be made more independent of the data provided to the apparatus, thereby making the apparatus more resistant to power analysis attacks. To facilitate this, circuit-matching may be performed, in which one of the power balanced logic structures comprises one or more logic gates that consume power and output a predetermined logic value.

Some of the data that is processed, such as one or more keys (e.g. public/private keys or secret/symmetric keys) may be pre-stored by the apparatus as one or more n-of-m codewords.

The apparatus may be any apparatus for performing a cryptographic process, such as an integrated-circuit device; a (cryptographic) smartcard, which may be contactless/proximity-based; a credit/debit card; a scrambling device for telephone communications; or a security device.

According to another aspect of the invention, there is provided a computer program that carries out one of the above-mentioned methods. The computer program may be carried on a data carrying medium such as a storage medium or a transmission medium.

According to another aspect of the invention, there is provided a method of forming an above-mentioned apparatus, the method comprising: receiving the above-mentioned computer program code; synthesising and mapping the computer program code to a target semiconductor technology, the apparatus using the target semiconductor technology; and forming the apparatus from the synthesised and mapped computer program code. The target semiconductor technology may be any suitable technology, such as an integrated circuit technology or a programmable device technology.

### BRIEF DESCRIPTION OF THE DRAWINGS

Embodiments of the invention will now be described, by way of example only, with reference to the accompanying drawings, in which:

FIG. 1a schematically illustrates a logic circuit for converting a pair of binary bits a₁a₀ to a 1-of-4 representation q₃q₂q₁q₀;

FIG. 1b schematically illustrates a logic circuit for converting a 1-of-4 representation a₃a₂a₁a₀ to a pair of binary bits q₁q₀;

FIG. 2a schematically illustrates a logic circuit for converting a 1-of-4 representation q₃q₂q₁q₀ to a pair of 1-of-2 representations b₁b₀, a₁a₀;

FIG. 2b schematically illustrates a logic circuit for converting a pair of 1-of-2 representations b₁b₀, a₁a₀ to a 1-of-4 representation q₃q₂q₁q₀;

FIG. 3a is a flowchart showing a high-level overview of the general processing according to an embodiment of the invention;

FIG. 3b is a flowchart showing a specific version of FIG. 3a when implementing AES128 encryption using a 1-of-4 representation;

FIGS. 4a-d schematically illustrate logic circuits for implementing a zero-state when an n-of-4 representation is being used;

FIG. 5a is a flowchart showing a high-level overview of the processing performed at the step S302 of FIG. 3a according to an embodiment of the invention;

FIG. 5b is a flowchart showing a specific version of FIG. 5a when implementing AES128 encryption using a 1-of-4 representation;

FIG. 6a schematically illustrates a logic circuit implementing a 1-of-2 XOR operation;

FIG. 6b schematically illustrates a logic circuit implementing a 1-of-2 AND operation;

FIG. 6c schematically illustrates a logic circuit implementing a 1-of-20R operation;

FIG. 7 schematically illustrates a logic circuit implementing GF(2²) addition, where the data is represented using the 1-of-4 codewords;

FIG. 8 schematically illustrates a non-power-balanced logic circuit implementing GF(2²) multiplication, where the data is represented using the 1-of-4 codewords;

FIG. 9 schematically illustrates a power-balanced logic circuit implementing GF(2²) multiplication, where the data is represented using the 1-of-4 codewords;

FIG. 10 schematically illustrates a logic circuit implementing GF(2²) division, where the data is represented using the 1-of-4 codewords;

FIG. 11 schematically illustrates a logic circuit implementing GF(2²) exponentiation, where the data is represented using the 1-of-4 codewords;

FIG. 12 schematically illustrates a logic circuit implementing a GF(2²) logical AND, where the data is represented using the 1-of-4 codewords;

FIG. 13 schematically illustrates a logic circuit implementing a GF(2²) logical OR, where the data is represented using the 1-of-4 codewords;

FIG. 14 schematically illustrates a logic circuit for performing GF(2⁴) addition using the GF(2²) adders of FIG. 7;

FIG. 15 schematically illustrates a logic circuit for performing GF(2⁴) multiplication using the GF(2²) adders of FIG. 7 and the GF(2²) multipliers of FIG. 9;

FIG. 16 schematically illustrates a logic circuit for performing GF(2⁴) inversion using the GF(2⁴) multipliers of FIG. 15;

FIG. 17 schematically illustrates a logic circuit for performing GF((2ⁿ)²) inversion;

FIG. 18 schematically illustrates a specific application of the logic circuit of FIG. 17 for performing GF(2⁸);

FIG. 19 schematically illustrated the processing performed at the step S552 of FIG. 5b;

FIG. 20 schematically illustrates the processing performed for the Round_1, Round_2, . . . , Round_9 operations of FIG. 19;

FIG. 21 schematically illustrates the AddRoundKey operation of FIG. 20;

FIG. 22 schematically illustrates the SubBytes operation of FIG. 20;

FIG. 23 schematically illustrates the MixColumns operation of FIG. 20;

FIG. 24 schematically illustrates the Linear_comb operation of FIG. 23;

FIG. 25 schematically illustrates a logic circuit for performing the constant multiplications in FIG. 24;

FIG. 26 schematically illustrates a device having a logic structure configured to perform cryptographic processing according to an embodiment of the invention;

FIG. 27 schematically illustrates a logic circuit implementing an extract processed for data represented using the 1-of-4 codewords;

FIGS. 28a and 28b schematically illustrate power balanced logic circuits implementing a 1-bit left rotation operation;

FIGS. 29a and 29b schematically illustrate power balanced logic circuits implementing a 1-bit right rotation operation;

FIG. 30 is a schematic overview of the Camellia-128 algorithm;

FIG. 31 schematically illustrates the processing for the first six rounds for the Camellia-128 algorithm;

FIG. 32 schematically illustrates an F function used in the Camellia-128 algorithm;

FIG. 33 schematically illustrates the processing for each of the four S-boxes of the Camellia-128 algorithm;

FIG. 34 schematically illustrates FL and FL⁻¹ functions that are used after the 6th and 12th rounds of the Camellia-128 algorithm;

FIG. 35 schematically illustrates a 1-of-4 comparator, for comparing two 1-of-4 codewords;

FIG. 36 schematically illustrates a wide 1-of-4 comparator;

FIG. 37 schematically illustrate an arrangement for multiplexing two 1-of-4 codewords, using logic gates;

FIG. 38 schematically illustrate an arrangement for multiplexing two 1-of-4 codewords, using binary multiplexers; and

FIGS. 39 and 40 schematically illustrate checkers for performing error-detection.

### DETAILED DESCRIPTION OF EMBODIMENTS OF THE INVENTION

In the description that follows and in the figures, certain embodiments of the invention are described. However, it will be appreciated that the invention is not limited to the embodiments that are described and that some embodiments may not include all of the features that are described below. It will be evident, however, that various modifications and changes may be made herein without departing from the broader scope of the invention as set forth in the appended claims.

1) Data Representations in an n-of-m Format

In the description that follows, the term “n-of-m codeword” or an “n-of-m representation” shall refer to a representation of data using m bits of which exactly n bits take a value of 1 and the remaining m-n bits take a value of 0, where m and n are positive integers with n<m. The number of distinct values that can be represented by a single n-of-m representation is

$$( \begin{matrix}m \\ n\end{matrix} )$$

and so the number of bits, R, that can be represented by a single n-of-m representation is

$$R = ⌊ {log}_{2} ( ( \begin{matrix}m \\ n\end{matrix} ) ) ⌋ .$$

Binary data can be represented in an n-of-m format by using one or more n-of-m codewords. If the binary data to be represented in an n-of-m format is S bits long, then the binary data can be viewed as being ┌S/R┐ blocks of R bits each, and each block can then be represented by a corresponding n-of-m representation/codeword. The binary data may need to be expanded (such as by appending 0-bits) in order to provide an integer number of blocks (i.e. so that S is an integer multiple of R).

As an example, in a 1-of-4 representation, 4 distinct values can be represented, with the different representations (or codewords) being: 0001, 0010, 0100 and 1000. Thus, two binary bits of data can be represented together as a single 1-of-4 representation, using, for example, the following mapping in table 1:

TABLE 1

| | 1-of-4 representation/ |
|---|---|
| Binary pair | codeword (q₃q₂q₁q₀) |
| 00 | 0001 |
| 01 | 0010 |
| 10 | 0100 |
| 11 | 1000 |

With this mapping, the binary string “011100” would be represented by the 1-of-4 representation “001010000001”.

It will be appreciated that other mappings are available for the 1-of-4 representation and that the above mapping is purely exemplary. However, this mapping shall be used for the rest of this document.

Similarly, in a 2-of-4 representation, there are six available different representations (or codewords): 0011, 0101, 0110, 1001, 1010 and 1100. Thus, two binary bits of data can be represented together as a single 2-of-4 representation. However, there are several different subsets of the six 2-of-4 codewords that can be used to represent the four different values expressible by the two binary bits of data. One example is given in table 2 below:

TABLE 2

| | 2-of-4 representation/ |
|---|---|
| Binary pair | codeword (q₃q₂q₁q₀) |
| 00 | 0101 |
| 01 | 0110 |
| 10 | 1001 |
| 11 | 1010 |

Similarly, in a 1-of-2 representation, two distinct values can be represented, with the different representations (or codewords) being: 01 and 10. Thus, one binary bit of data can be represented as a single 1-of-2 representation, using, for example, the following mapping in table 3:

TABLE 3

| | 1-of-2 representation/ |
|---|---|
| Binary bit | codeword (a₁a₀) |
| 0 | 01 |
| 1 | 10 |

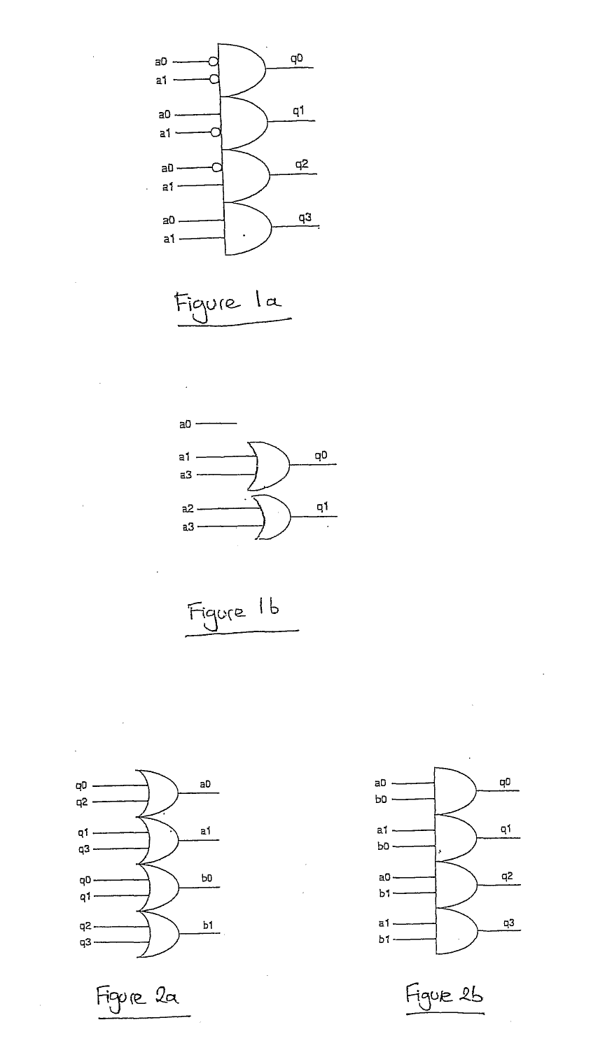

As mentioned above, there are a variety of possible mappings between the n-of-m representations and the actual binary data being represented, and the skilled person will appreciate that this can be achieved in logic gates in a variety of ways. FIG. 1a schematically illustrates a logic circuit for converting a pair of binary bits a₁a₀ to a 1-of-4 representation q₃q₂q₁q₀, whilst FIG. 1b schematically illustrates a logic circuit for converting a 1-of-4 representation a₃a₂a₁a₀ to a pair of binary bits q₁q₀. These logic circuits are based on the mappings between 1-of-4 and binary data described in table 1 above. It will be appreciated, though, that other logic circuits may be used to achieve the same mappings, and that mappings between binary and other n-of-m formats can be achieved using analogous logic circuits.

It will also be appreciated that it may sometimes be useful to swap between a first n₁-of-m₁ format and a second n₂-of-m₂ format. For example, the 1-of-4 format can be used to represent pairs of binary bits. However, to process a single bit, it may be more convenient to convert the 1-of-4 representation of a pair of binary bits to a pair of 1-of-2 representations, with each of the 1-of-2 codewords representing one of the bits of the pair of binary bits. Using the mappings discussed above in tables 1 and 3 between binary and 1-of-4 and 1-of-2 representations, the following mapping (in table 4) between 1-of-4 and 1-of-2 representations can be used:

TABLE 4

| | 1-of-2 representations/ | 1-of-4 representation/ |
|---|---|---|
| Binary pair | codewords (b₁b₀ a₁a₀) | codeword (q₃q₂q₁q₀) |
| 00 | 01 01 | 0001 |
| 01 | 01 10 | 0010 |
| 10 | 10 01 | 0100 |
| 11 | 10 10 | 1000 |

It will be appreciated that the set of pairs of 1-of-2 codewords is a subset of the available 2-of-4 codewords (see tables 2 and 4 above) and hence the mapping shown in table 4 may be viewed as a mapping from/to a 1-of-4 codeword to/from a 2-of-4 codeword.

FIG. 2a schematically illustrates a logic circuit for converting a 1-of-4 representation q₃q₂q₁q₀ to a 2-of-4 codeword b₁b₀a₁a₀ (i.e. a pair of 1-of-2 representations b₁b₀, a₁a₀). FIG. 2b schematically illustrates a logic circuit for converting a 2-of-4 codeword b₁b₀a₁a₀ (i.e. a pair of 1-of-2 representations b₁b₀, a₁a₀) to a 1-of-4 representation q₃q₂q₁q₀. These logic circuits are based on the above mappings shown in tables 2 and 4. It will be appreciated, though, that other logic circuits may be used to achieve the same mappings, and that mappings between other different n-of-m formats can be achieved using analogous logic circuits.

2) Processing Data in an n-of-m Format

In embodiments of the invention, a cryptographic algorithm is implemented such that the algorithm processes data (such as plaintext, ciphertext, keys, intermediate states/variables, etc.) in an n-of-m format. Input binary data is converted into the n-of-m format (as described above) and is then processed in the n-of-m format. Once the data in the n-of-m format has been processed, the processed data that is output from the cryptographic algorithm can be converted from the n-of-m format back to the original binary representation.

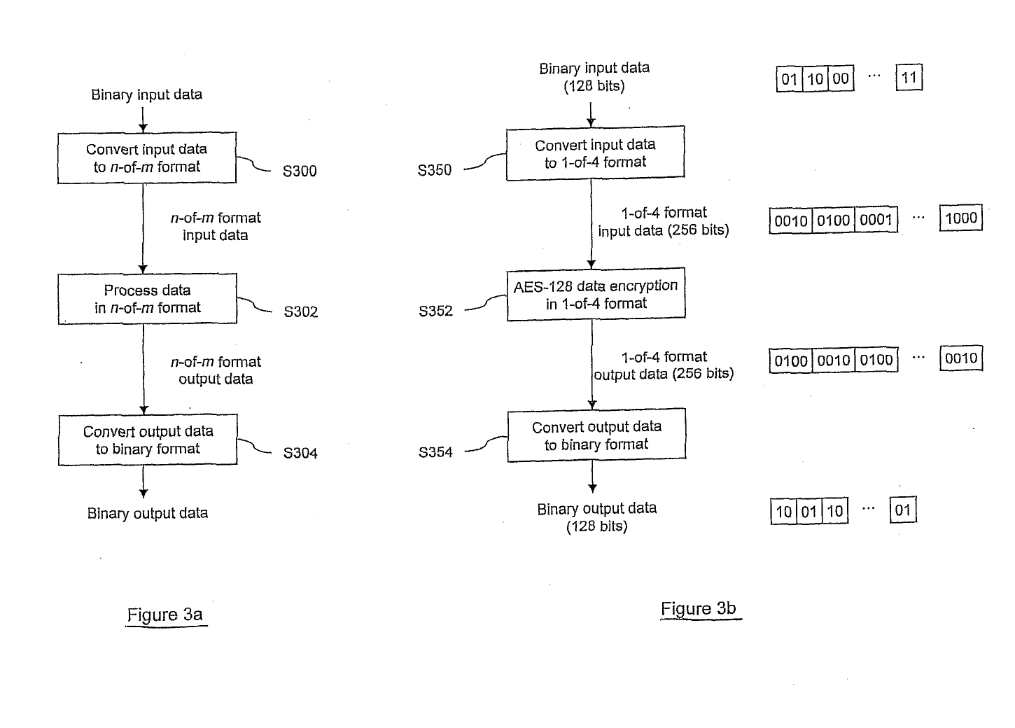

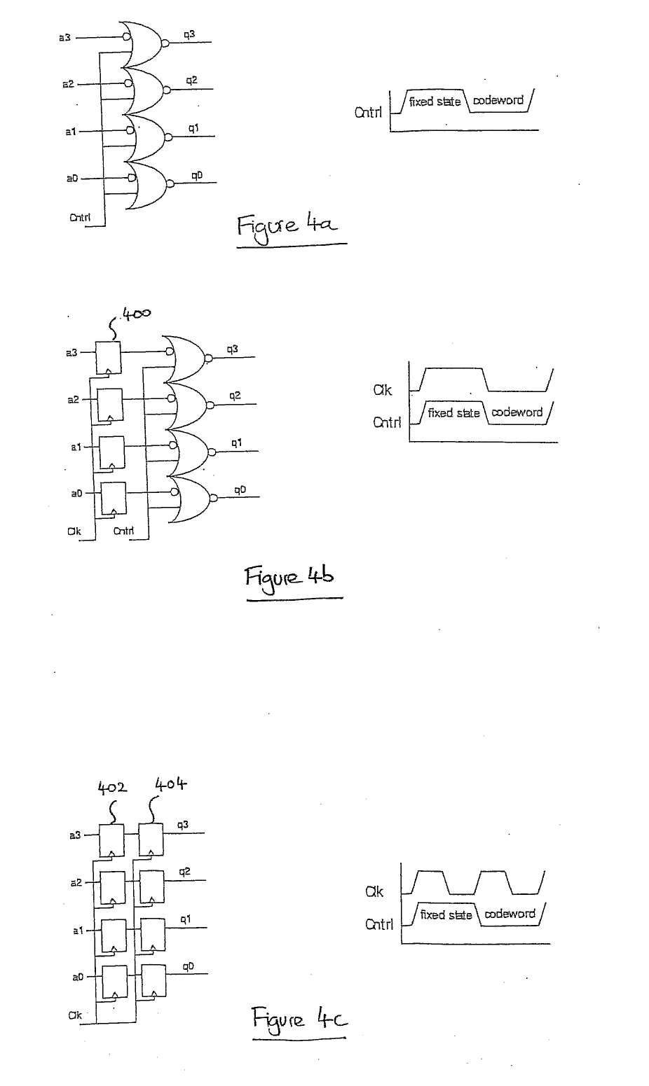

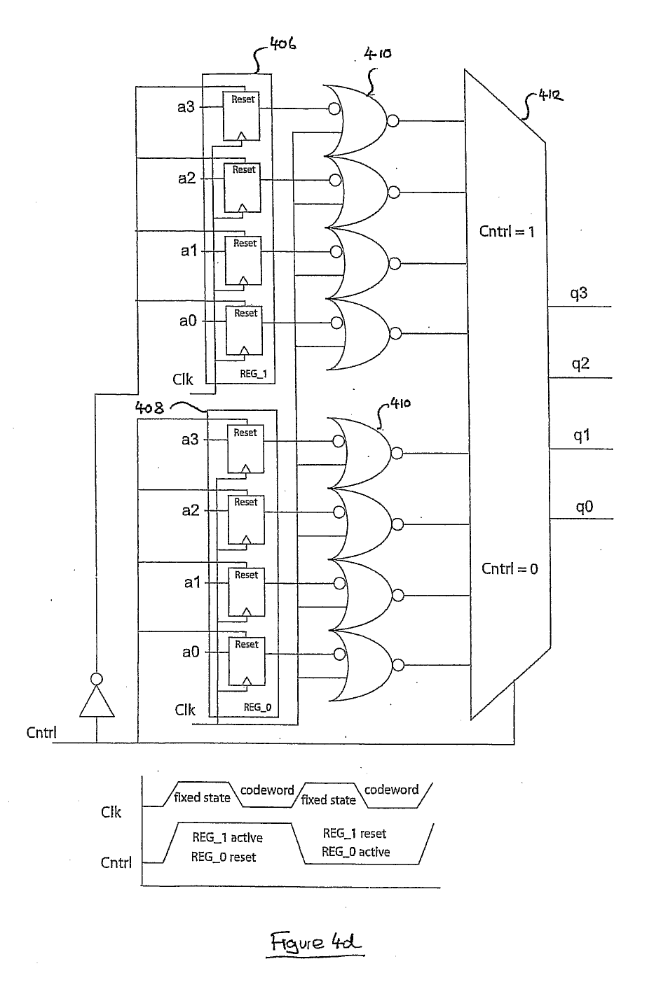

FIG. 3a is a flowchart showing a high-level overview of the general processing according to an embodiment of the invention. FIG. 3b is a flowchart showing a specific version of FIG. 3a when implementing AES128 encryption using a 1-of-4 representation. AES128 encryption is a well-known encryption algorithm (see http://csrc.nist.gov/publications/fips/fips197/fips−197.pdf, the entire disclosure of which is incorporated herein by reference).

In FIG. 3a, at a step S300 input binary data is converted from the binary format to an n-of-m format. This corresponds to a step S350 in FIG. 3b at which an input block of 128 bits of binary data is converted to the 1-of-4 format. For example, the first two bits of binary input data are “01”, which are converted to a corresponding 1-of-4 representation “0010”, whilst the second two bits of binary input data are “10”, which are converted to a corresponding 1-of-4 representation “0100”. Thus, the output of the step S350 is 256 bits of 1-of-4 codewords.

Next, at a step S302 in FIG. 3a, the input data in the n-of-m format is processed in the n-of-m format. This corresponds to a step S352 in FIG. 3b at which AES128 encryption is performed on the input 256 bits of the 1-of-4 formatted data. It will be appreciated that the hardware implementation for the steps S302, S352 needs to be configured to receive, operate on, process and output data in the n-of-m (or, for FIG. 3b, 1-of-4) format. This will be described in more detail below with reference to the AES128 and the Camellia-128 algorithms as examples.

Then, at a step S304 in FIG. 3a, the processed output data in the n-of-m format is converted back to the binary format. This corresponds to a step S354 in FIG. 3b at which the encrypted data in the 1-of-4 format is converted back to binary form. For example, the 1-of-4 codeword of the output 1-of-4 formatted ciphertext is “0100”, which is converted to a corresponding binary representation of “10”, whilst the second 1-of-4 codeword of the output 1-of-4 formatted ciphertext is “0010”, which is converted to a corresponding binary representation of “01”.

It will be appreciated that some embodiments of the invention may not implement the step S300 (S350) and/or the step S304 (S354). Instead, the processing performed at the step S300 (S350) and/or the step S304 (S354) may be implemented as a separate hardware interface(s) to the hardware implementation of the embodiment of the invention, i.e. the input data may be received in the n-of-m format and hence does not need to be converted into the n-of-m format for processing, or it may be desirable to leave the output data in the n-of-m format, e.g. for transmission elsewhere.

Additionally, some of the data required for the processing (such as one or more secret keys) may already be stored within the hardware implementation in the n-of-m format. For example, a smartcard implementing the method illustrated in FIG. 3b may store the secret keys used for the AES128 encryption within the smartcard in the 1-of-4 format. Hence, this particular input data for the AES128 encryption need not be converted from a binary format (although input plaintext may need converting from the binary format).

### 3) Mappings Between Galois Fields

In this document, the term GF(w) represents a Galois field (a finite field) of size w, where w=λ^{k} for some prime value λ known as the characteristic of the Galois field. It is well-known that all Galois fields of size w are the same up to isomorphism.

GF(2⁸) is isomorphic to the composite field GF((2⁴)²). In particular, an element a of GF(2⁸) can be represented by the polynomial a₇x⁷+a₆x⁶+a₆x⁶+a₄x⁴+a₃x³+a₂x²+a₁x¹+a₀, where aᵢεGF(2). Additionally, the element a of GF(2⁸) can be represented by the polynomial aₕx+aₗ, where aₕ, aₗεGF(2⁴). As elements of GF(2⁴), both aₕ and aₗ can be represented by polynomials aₕ_{₃}x³+aₕ_{₂}x²+aₕ_{₁}x+aₕ_{₀} and aₗ_{₃}x³+aₗ_{₂}x²+aₗ_{₁}x+aₗ_{₀} respectively, where aₕ_{ᵢ}, aₗ_{ᵢ}εGF(2).

There are many isomorphisms from GF(2⁸) to the composite field GF((2⁴)²), as are well known in this field of technology. One such isomorphism may be defined using the following binary equations, using the above notation:

aₗ_{₀}=a₀⊕a₂⊕a₃⊕a₄⊕a₆⊕a₇

aₗ_{₁}=a₁⊕a₃

aₗ_{₂}=a₁⊕a₄⊕a₆

aₗ_{₃}=a₁⊕a₂⊕a₆⊕a₇

aₕ_{₀}=a₄⊕a₅⊕a₆

aₕ_{₁}=a₁⊕a₄⊕a₆⊕a₇

aₕ_{₂}=a₂⊕a₃⊕a₅⊕a₇

aₕ_{₃}=a₅⊕a₇

This isomorphism has the following inverse:

a₀=aₗ_{₀}⊕aₕ_{₀}⊕aₕ_{₂}

a₁=aₕ_{₀}⊕aₕ_{₁}⊕aₕ_{₃}

a₂=aₗ_{₁}⊕aₕ_{₀}⊕aₕ_{₁}⊕aₕ_{₂}

a₃=aₗ_{₁}⊕aₕ_{₀}⊕aₕ_{₁}⊕aₕ_{₃}

a₄=aₗ_{₁}⊕aₗ_{₃}⊕aₕ_{₀}⊕aₕ_{₂}

a₅=aₗ_{₂}⊕aₕ_{₁}⊕aₕ_{₃}

a₆=aₗ_{₁}⊕aₗ_{₂}⊕aₗ_{₃}⊕aₕ_{₁}⊕aₕ_{₂}⊕aₕ_{₃}

a₇=aₗ_{₂}⊕aₕ_{₁}

Additionally, GF(2⁴) is isomorphic to the composite field GF((2²)²). In particular, an element a of GF(2⁴) can be represented by the polynomial a₃x³+a₂x²+a₁x+a₀, where aᵢεGF(2). Additionally, the element a of GF(2⁴) can be represented by the polynomial aₕx+aₗ, where aₕ, aₗεGF(2²). As elements of GF(2²), both aₕ and aₗ can be represented by polynomials aₕ_{₁}x+aₕ_{₀} and aₗ_{₁}x+aₗ_{₀}, respectively, where aₕ_{ᵢ}, aₗ_{ᵢ}εGF(2).

There are many isomorphisms from GF(2⁴) to the composite field GF((2²)²), as are well known in this field of technology. One such isomorphism may be defined using the following binary equations, using the above notation:

aₗ_{₀}=a₀⊕a₁

aₗ_{₁}=a₁⊕a₃

aₕ_{₀}=a₁⊕a₂

aₕ_{₁}=a₃

This isomorphism has the following inverse:

a₀=aₗ_{₀}⊕aₗ_{₁}⊕aₕ_{₁}

a₁=aₗ_{₁}⊕aₕ_{₁}

a₂=aₗ_{₁}⊕aₕ_{₀}⊕aₕ_{₁}

a₃=aₕ_{₁}

The above isomorphisms use:
(i) the polynomial x⁸+x⁴+x³+x²+1 (which is irreducible over GF(2)) to construct GF(2⁸) as an extension of GF(2);
(ii) the polynomial x²+x+γ (which is irreducible over GF(2⁴)) to construct the composite field GF((2⁴)²) as an extension of GF(2⁴), where γ is a primitive root of GF(2⁴). Several such values of γ exist and may be chosen, for example, to minimize, or at least reduce, the above mappings (i.e. minimize or reduce the number of XOR operations used in the above equations);
(iii) the polynomial x⁴+x+1 (which is irreducible over GF(2)) to construct GF(2⁴) as an extension of GF(2);
(iv) the polynomial x²+x+μ (which is irreducible over GF(2²)) to construct the composite field GF((2²)²) as an extension of GF(2²), where μ is a primitive root of GF(2²). Several such values of μ exist and may be chosen, for example, to minimize, or at least reduce, the above mappings (i.e. minimize or reduce the number of XOR operations used in the above equations); and
(v) the polynomial x²+x+1 (which is irreducible over GF(2)) to construct GF(2²) as an extension of GF(2).

With a combination of these isomorphisms, an element a of GF(2⁸) can be mapped to a pair of elements aₕ and aₗ of GF(2⁴), and each of these elements of GF(2⁴) can then be mapped to corresponding pairs of elements aₕ_{₁}, aₕ_{₀} and aₗ_{₁}, aₗ_{₀} of GF(2²), so that the element a of GF(2⁸) is mapped to the tuple of elements aₕ_{₁}, aₕ_{₀}, aₗ_{₁}, aₗ_{₀} of GF(2²). Similarly, corresponding inverse mappings exists.

A mapping from an element of GF(2⁸) to a 4-tuple of elements of GF(2²) can be achieved by initially mapping the element of GF(2⁸) to a pair of elements of GF(2⁴), and then mapping each of these elements of GF(2⁴) to a pair of elements of GF(2²). Alternatively, the mapping could be achieved directly from the element of GF(2⁸) to the 4-tuple of elements of GF(2²) without going through GF(2⁴), for example by combining the above Boolean equations for the two isomorphisms. The same applies equally to the inverse mappings.

It will be appreciated that, in general, isomorphisms exist between GF(2^{k}) and the composite field GF((2^{r})^{s}), where k=rs, so that any element of GF(2^{k}) can be mapped (transformed) to an s-tuple of elements of GF(2^{r}), and vice versa. Indeed, this does not depend upon the Galois field having a characteristic of 2, but applies generally to Galois fields of other characteristics λ, such as 3, so that isomorphisms exist between GF(λ^{k}) and the composite field GF((λ^{r})^{s}), where k=rs, so that any element of GF(λ^{k}) can be mapped (transformed) to an s-tuple of elements of GF(λ^{r}), and vice versa.

4) Algorithmic Processing Using Galois Fields and n-of-m Representations

Many cryptographic algorithms treat data (such as plaintext, ciphertext, keys, intermediate values, etc.) as elements of a Galois field. For example, the AES128 algorithm treats bytes of data as elements of GF(2⁸), where GF(2⁸) is constructed using the polynomial x⁸+x⁴+x³+x+1 which is irreducible over GF(2). A byte b₇ b₆ b₅ b₄ b₃ b₂ b₁b₀ of bits bᵢ is then treated as the polynomial b₇x⁷+b₆x⁶+b₅x⁵+b₄x⁴+b₃x³+b₂x²+b₁x+b₀. Bytes can then be added and multiplied using the addition and multiplication of GF(2⁸). In particular, addition of two bytes involves XOR-ing the bytes, whilst multiplying two bytes involves multiplying the corresponding polynomials modulo the irreducible polynomial x⁸+x⁴+x³+x+1.

Other cryptographic algorithms (such as in elliptic curve cryptography) may treat data as elements of other Galois fields, and then operate on the data using operations (such as addition, multiplication, inversion, etc.) applicable to the Galois field being used. Some of these algorithms use Galois fields of characteristic 2, whilst others use Galois fields of other different characteristic, such as 3. However, the description that follows applies generally to any Galois field characteristic.

Elements of Galois fields can be represented by appropriate n-of-m codewords. An element of the Galois field could be represented by a combination of several n-of-m codewords, depending on the choice of n and m. To represent an element of the Galois field with a single n-of-m codeword, n and m are chosen so that the number R of different n-of-m codewords is at least the size of the Galois field. For example, GF(2²) can be constructed from GF(2) using the polynomial x²+x+1 which is irreducible over GF(2). Hence the elements of GF(2) can be considered to be the polynomials modulo x²+x+1 over GF(2), i.e. 0, 1, x and x+1. These elements of GF(2) can be mapped to a 1-of-4 representation as shown in table 5 below, although it will be appreciated that other mappings between the elements of GF(2²) and the 1-of-4 codewords could be used instead:

TABLE 5

| Element of | | Binary | 1-of-4 representation/ | 2-of-4 representation/ |
|---|---|---|---|---|
| GF(2²) | Polynomial | representation | codeword | codeword |
| 0 | 0 | 00 | 0001 | 0101 |
| 1 | 1 | 01 | 0010 | 0110 |
| 2 | x | 10 | 0100 | 1001 |
| 3 | x + 1 | 11 | 1000 | 1010 |

Similarly, elements of GF(2²) may be represented by 2-of-4 codewords, as is also shown in table 5.

Elements of GF(3) may be presented by 1-of-3 or 2-of-3 codewords, as shown in table 6 below.

TABLE 6

| Element of | | Binary | 2-of-3 representation/ | 1-of-3 representation/ |
|---|---|---|---|---|
| GF(3) | Polynomial | representation | codeword | codeword |
| 0 | 0 | 00 | 011 | 001 |
| 1 | 1 | 01 | 101 | 010 |
| 2 | x | 10 | 110 | 100 |

A byte of data (having 256 different possible values) could be represented as a 1-of-256 codeword. An embodiment of the invention could then implement the AES128 algorithm by using logic structures that implement operations, such as addition or multiplication, in GF(2⁸), with these logic structures receiving one or more 1-of-256 codewords as inputs and outputting one or more 1-of-256 codewords as outputs.

However, as discussed above, GF(2⁸) is isomorphic to GF((2⁴)²). There are 16 elements of GF(2⁴), and so the elements of GF(2⁴) can be represented by respective 1-of-16 codewords. Hence, a byte of data could be represented by a pair of 1-of-16 codewords. An embodiment of the invention could then implement the AES128 algorithm by using logic structures that implement operations, such as addition or multiplication, in GF(2⁴), with these logic structures receiving one or more 1-of-16 codewords as inputs and outputting one or more 1-of-16 codewords as outputs. Operations in GF(2⁸) may then be implemented by combining these underlying logic structures that implement operations in GF(2⁴).

Furthermore, as discussed above, GF(2⁸) is isomorphic to GF((2²)²)²). As discussed above, the elements of GF(2²) can be represented by respective 1-of-4 codewords. Hence, a byte of data could be represented by a 4-tuple of 1-of-4 codewords. An embodiment of the invention could then implement the AES128 algorithm by using logic structures that implement operations, such as addition or multiplication, in GF(2²), with these logic structures receiving one or more 1-of-4 codewords as inputs and outputting one or more 1-of-4 codewords as outputs. Operations in GF(2⁴) may then be implemented by combining these underlying logic structures that implement operations in GF(2²), and then operations in GF(2⁸) may be implemented by combining the logic structures that have been formed for implementing operations in GF(2⁴).

In general, though, it will be appreciated that a cryptographic algorithm that considers an amount of data to be an element of GF(2^{k}), could be implemented by representing that amount of data as a corresponding n-of-m codeword, where n and m are chosen such that the number of bits that the set of n-of-m codewords can represent is at least k bits (such as a 1-of-2^{k} representation). Embodiments of the invention may then implement the cryptographic algorithm by processing the data (keys, plaintext, ciphertext, intermediate values, etc.) in the appropriate n-of-m format.

Similarly, as GF(2^{k}) is isomorphic to the composite field GF((2^{r})^{s}), where k=rs, it will be appreciated that a cryptographic algorithm that considers an amount of data (k bits) to be an element of GF(2^{k}), could be implemented by representing that amount of data as a corresponding s-tuple of n-of-m codewords, where n and m are chosen such that the number of bits that the set of n-of-m codewords can represent is at least r bits (such as a 1-of-2^{r} representation). Embodiments of the invention may then implement the cryptographic algorithm by processing the data (keys, plaintext, ciphertext, intermediate values, etc.) in the appropriate n-of-m format. Using this composite field representation can make the implementation easier to perform, as the GF(2^{r}) operations can be easier to implement than the GF(2^{k}) operations. For example, the area required within an integrated circuit when implementing the GF(2^{r}) operations may be less than when implementing the GF(2^{k}) operations directly and the power consumption of an integrated circuit implementing the GF(2^{r}) operations may be less than one implementing the GF(2^{k}) operations directly.

It will be appreciated that the same applies to Galois fields of characteristic other than 2. In particular, a cryptographic algorithm may consider an amount of data to be an element of GF(λ^{k}), and this may be implemented by representing that amount of data as a corresponding n₁-of-m₁ codeword, where n₁ and m₁ are chosen such that there are sufficient n₁-of-m₁ codewords to represent all possible values for this amount of data. Embodiments of the invention may then implement the cryptographic algorithm by processing the data (keys, plaintext, ciphertext, intermediate values, etc.) in the appropriate n₁-of-m₁ format. However, as GF(λ^{k}) is isomorphic to the composite field GF((λ^{r})^{s}), where k=rs, the cryptographic algorithm could be implemented by representing that amount of data as a corresponding s-tuple of one or more n₂-of-m₂ codewords, where n₂ and m₂ are chosen such that this amount of data may be represented by an s-tuple of n₂-of-m₂ codewords. Embodiments of the invention may then implement the cryptographic algorithm by processing the data (keys, plaintext, ciphertext, intermediate values, etc.) in the appropriate n₂-of-m₂ format.

When this composite field representation is used, it may be necessary to convert an element of GF(λ^{k}) received as part of the input data at the step S302 in FIG. 3a in the n-of-m format to an s-tuple of elements of GF(λ^{r}) in the n-of-m format. It may then be necessary to convert an s-tuple of elements of GF(λ^{r}) output as part of the output data at the step S302 in the n-of-m format to an element of GF(λ^{k}) in the n-of-m format. This conversion/transformation between GF(λ^{k}) and GF(λ^{r}) will be described in more detail below.

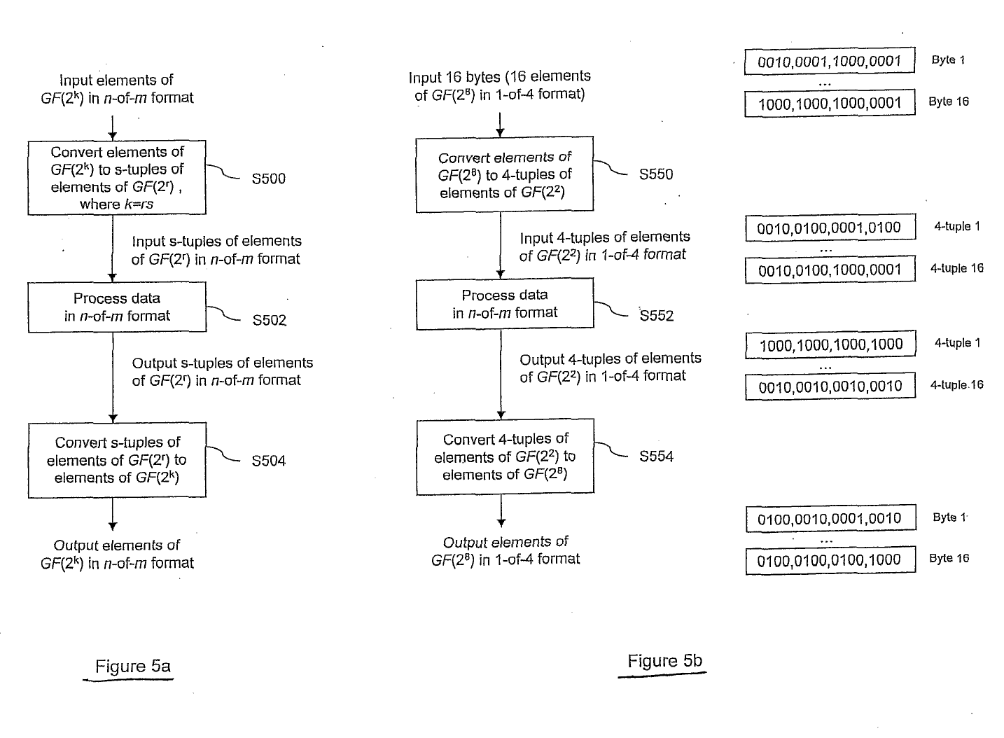

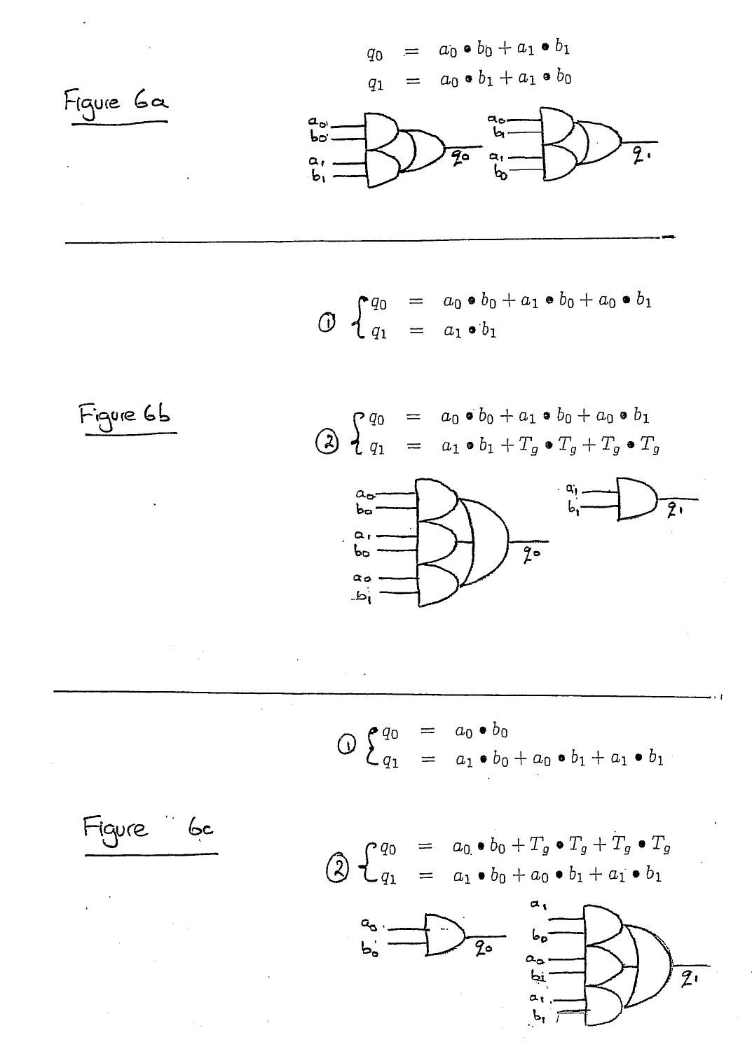

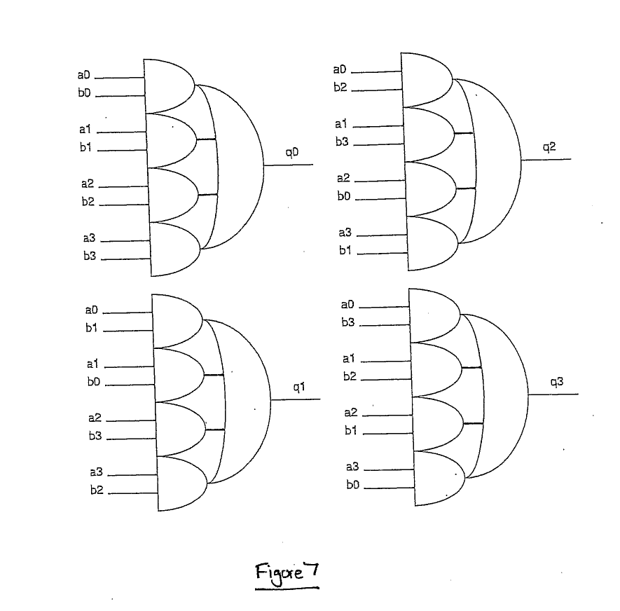

FIG. 5a is a flowchart showing a high-level overview of the processing performed at the step S302 of FIG. 3a according to an embodiment of the invention when the above-mentioned field conversions are implemented. Here, the field is shown as having characteristic 2, although this is merely an example.

FIG. 5b is a flowchart showing a specific version of FIG. 5a when implementing AES128 encryption using a 1-of-4 representation. As mentioned above, for AES128 encryption, bytes of data are considered elements of GF(2⁸), i.e. k=8. An input byte of data (i.e. an input element of GF(2⁸)) is received, at the step S302 of FIG. 3a as four 1-of-4 codewords. As GF(2⁸) is isomorphic to GF((2²)⁴), the bytes of input data can be mapped to respective 4-tuples of elements of GF(2²) (using the above-mentioned isomorphisms), with each element of GF(2²) having its own 1-of-4 codeword. The AES128 encryption can then be implemented using GF(2²) operations (such as addition and multiplication) performed on the elements of GF(2²).

At a step S500 in FIG. 5a, the data in the n-of-m format is received. The data may comprise one or more elements of GF(2^{k}), with each element represented by one or more n-of-m codewords. This corresponds to a step S550 in FIG. 5b at which the 16 bytes of data (128 bits) are received in the 1-of-4 format. This is equivalent to receiving 16 elements of GF(2⁸), with each element represented by four 1-of-4 codewords. For example, the first byte shown in FIG. 5b is 01001100, which is received as the 1-of-4 codewords 0010, 0001, 1000, 0001 and the 16^{th} byte shown in FIG. 5b is 00111111, which is received as the 1-of-4 codewords 0001, 1000, 1000, 1000.

At the step S500, the elements of GF(2^{k}) are mapped (transformed) to s-tuples of elements of GF(2^{r}). This involves using an appropriate isomorphism between GF(2^{k}) and the composite field GF((2^{r})^{s}), as discussed above. In the particular example shown in FIG. 5b, the above-mentioned mapping of an element a of GF(2⁸) to 4-tuple of elements aₕ_{₁}, aₕ_{₀}, aₗ_{₁}, aₗ_{₀} of GF(2²) can be used.

For example, the first input byte a₇a₆a₅a₄a₃a₂a₁a₀=01001100 (received as the 1-of-4 codewords 0010, 0001, 1000, 0001 and considered as an element of GF(2⁸)) is mapped to the 4-tuple of elements of GF(2²): aₕ_{₁}=01, aₕ_{₀}=10, aₗ_{₁}=00, aₗ_{₀}=10. These elements of GF(2²) can be represented by the 4-tuple of 1-of-4 codewords 0010, 0100, 0001, 0100.

Similarly, the 16^{th} input byte 11111100 (received as the 1-of-4 codewords 1000, 1000, 1000, 0001 and considered as an element of GF(2⁸)) is mapped to the 4-tuple of elements of GF(22): aₕ_{₁}=01, aₕ_{₀}=10, aₗ_{₁}=11, aₗ_{₀}=00. These elements of GF(2²) can be represented by the 4-tuple of 1-of-4 codewords 0010, 0100, 1000, 0001.

Then, at a step S502, the data in the n-of-m format output from the step S500 is processed according to the cryptographic algorithm steps specific to the cryptographic algorithm being implemented. The output of the step S502 is s-tuples of elements of GF(2^{r}). It will be appreciated that the cryptographic processing performed at the step S502 may be any form of cryptographic processing, including symmetric (secret-key) and asymmetric (public-key) algorithms.

This corresponds to a step S552 in FIG. 5b at which the AES128 encryption is performed. An example of the implementation of AES128 using the 1-of-4 format and built on logic structures operating in GF(2²) will be described in more detail below. The output of the encryption is 16 bytes of ciphertext data (128 bits), which is output as 16 4-tuples of elements of GF(2²), with these element of GF(2²) being represented in the 1-of-4 format.

At the step S504, the s-tuples of elements of GF(2^{r}) are mapped (transformed) to elements of GF(2^{k}). This involves using the appropriate inverse of the isomorphism that was used at the step S500 to map between GF(2^{k}) and the composite field GF((2^{r})^{s}). In the particular example shown in FIG. 5b, the inverse mapping used is the inverse of the above-mentioned mapping that maps an element a of GF(2⁸) to the 4-tuple of elements aₕ_{₁}, aₕ_{₀}, aₗ_{₁}, aₗ_{₀} of GF(2²).

For example, the first 4-tuple of elements of GF(2²) output by the step S552 is: aₕ_{₁}=11, aₕ_{₀}=11, aₗ_{₁}=11, aₗ_{₀}=11 (output as the 4-tuple of 1-of-4 codewords 1000, 1000, 1000, 1000). This 4-tuple is mapped to the byte a₇a₆a₅a₄a₃a₂a₁a₀=10010001 as an element of GF(2⁸) (represented as the 1-of-4 codewords 0100, 0010, 0001, 0010).

Similarly, the 16^{th} 4-tuple of elements of GF(2²) output by the step S552 is: aₕ_{₁}=01, aₕ_{₀}=01, aₗ_{₁}=01, aₗ_{₀}=01 (output as the 4-tuple of 1-of-4 codewords 0010, 0010, 0010, 0010). This 4-tuple is mapped to the byte a₇a₆a₅a₄a₃a₂a₁a₀=10101011 as an element of GF(2⁸) (represented as the 1-of-4 codewords 0100, 0100, 0100, 1000).

The actual implementation of the isomorphism (or the inverse of thereof) from GF(λ^{k}) to the composite field GF((λ^{r})^{s}) using the n-of-m codewords can be performed in many ways, as discussed below.

In one embodiment, equations are derived to map the bits of the n-of-m codeword(s) representing an element of GF(λ^{k}) to the bits of the corresponding s-tuple of n-of-m codeword(s) representing the corresponding s-tuple of GF(λ^{r}) elements. To do this, use is made of the equations mapping the polynomial coefficients representing an element of GF(λ^{k}) to the polynomial coefficient representing the s-tuple of corresponding GF(λ^{r}) elements, such as the example Boolean equations given above for the isomorphisms between GF(2⁸) and GF((2⁴)²), and the isomorphisms between GF(2⁴) and GF((2²)²). Once the mapping between polynomial coefficients have been determined for the isomorphism, then it can be determined how to map the corresponding bits of the n-of-m codewords representations. Logic structures can then be implemented to perform this mapping (such as the circuits shown in FIGS. 2a and 2b). For example, using the above isomorphism Boolean equations, the polynomial coefficients 01001100 of an element of GF(2⁸) is mapped to the 4-tuple of polynomial coefficients 01, 10, 00, 10 of elements of GF(2²). From this, it is determined that the 1-of-4 codewords representing the element of GF(2⁸) 0010, 0001, 1000, 0001 is mapped to 1-of-4 codewords representing the 4-tuple of elements of GF(2²) 0010, 0100, 0001, 0100. In this way, it can be determined where to map the bits of the 1-of-4 codewords for the element of GF(2⁸) to in order to represent the four elements of GF(2²) as 1-of-4 codewords.

In an alternative embodiment of the invention, the actual implementation of the isomorphism (or the inverse of thereof) from GF(λ^{k}) to the composite field GF((λ^{r})^{s}) using the n-of-m codewords is performed by first mapping an n-of-m codeword to a tuple of 1-of-λ codewords. Each 1-of-λ codeword then represents a corresponding coefficient of the polynomial representation over GF(λ) of the element of GF(λ^{k}). For example, using the logic circuit shown in FIG. 2a, a 1-of-4 codeword representing an element of GF(2²) can be mapped to a pair of 1-of-2 codewords (equivalently, a corresponding 2-of-4 codeword). Each 1-of-2 codeword then represents a single polynomial coefficient of the corresponding polynomial representation of the element of GF(2²) over GF(2). For example, an element x+1 of GF(2²) can be represented by the 1-of-4 codeword 1000 (see table 5 above). This can be mapped via the logic circuit of FIG. 2a to two 1-of-2 codewords (both 10), which each represent a corresponding coefficient of the polynomial representation x+1.

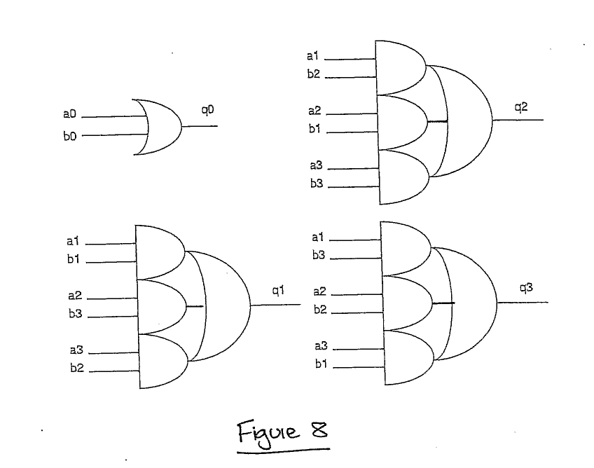

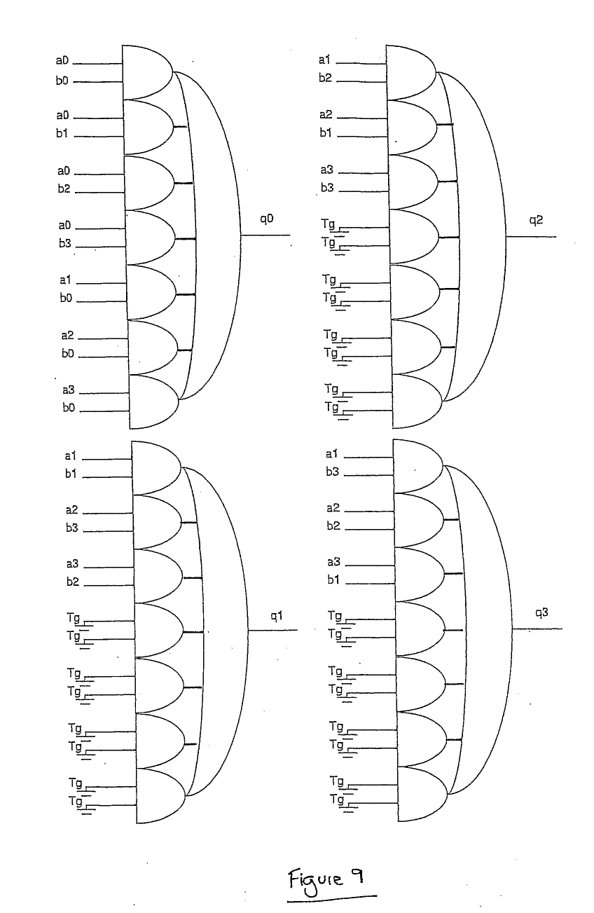

Once the 1-of-λ, codewords have been attained, then 1-of-λ XOR operations can be performed according to the actual isomorphism (or inverse thereof) to be implemented. For example, the Boolean equations provided in section 3 above could be implemented using 1-of-2 XOR operations. FIG. 6a schematically illustrates a logic circuit for implementing a 1-of-2 XOR operation, with input 1-of-2 codewords a₁a₀ and b₁b₀ and output 1-of-2 codeword q₁q₀, together with the Boolean logic equations used for the 1-of-2 XOR operation.

Having performed the 1-of-λ XOR operations to implement the respective equations for calculating the polynomial coefficients of the polynomial representations over GF(λ) of the elements of the s-tuple of GF(λ^{r}) elements, the 1-of-λ codewords can be mapped back to n-of-m codewords. For example, the logic circuit shown in FIG. 2b can be used to map a pair of 1-of-2 codewords to a 1-of-4 codeword. The result of this is then an s-tuple of n-of-m codewords representing an s-tuple of elements of GF(λ^{r}).

It will be appreciated that a similar approach can be used to implement any set of logic (Boolean) equations, and not just equations for isomorphisms.

### 5) Power Balancing and Power Analysis Attacks

As embodiments of the invention process data represented as n-of-m codewords, in a hardware implementation of an embodiment of the invention, m lines (wires/connectors) are used to implement a single n-of-m codeword. Each of these m lines has a voltage (high or low) that represents a respective one of the m bits used for the n-of-m representation. A 1-bit is usually represented by a relatively higher voltage and a 0-bit is usually represented by a relatively lower voltage. Logic gates require power to produce these respective voltages, with more power being required to produce a high voltage (a 1-bit) than a low voltage (a 0-bit).

Given the nature of the n-of-m format, at any time at which data is being represented, only n out of these m lines will be active (or have a high voltage) to represent corresponding 1-bits of the n-of-m codewords. The other m-n lines will be inactive (or have a low voltage) to represent corresponding 0-bits of the n-of-m codeword. In other words, no matter what value the binary data takes, for the corresponding n-of-m codeword the number of lines that are active out of the m lines will be the constant value n. Hence the power usage of the hardware implementation can be made more data independent by processing the data in the n-of-m format, thereby making the hardware implementation less vulnerable to power analysis attacks.

For example, processing a pair of binary bits of data in the 1-of-4 format means that 4 lines are used to represent the pair of binary bits, but at any stage, only one of the 4 lines is ever active. In contrast, processing the pair of binary bits in binary format would involve 2 lines, but the number of lines that are active would vary from 0 to 2 depending on the actual data values of the pair of binary bits. In other words, processing the data in the 1-of-4 format has a power consumption that is more independent of the actual data, whilst processing the data in the binary format has a power consumption that is more dependent on the actual data.

In some embodiments of the invention, a fixed intermediate-state is used between cycles of computation. This state is used to separate meaningful transitions to and from n-of-m codewords, even if the same codeword occurs in the next cycle. In the intermediate-state, a predetermined value of “00 . . . 0” (i.e. m 0-bits) is used, thereby setting all the m lines for an n-of-m representation to inactive. This can be seen as deactivating the n active lines at the beginning of the intermediate-state and then activating n of the m lines at the beginning of the next computation cycle depending on the next n-of-m codeword to be used.

The use of the intermediate-state provides a deterministic order of switching from a computation cycle to the fixed value and back to a computation cycle, and ensures that the same number of switching events (activating/deactivating of lines) occurs regardless of the data being processed, in particular if successive n-of-m codewords are the same.

As an example without the intermediate-state being used, if two successive 1-of-4 codewords to be processed are 0100 and 1000, then a deactivation of one line and an activation of another line would occur during the transition between the codewords. With successive 1-of-4 codewords of 0100 and 0100, no deactivation or activation would need to occur. This difference of switching when successive codewords are the same or are different could leak information during a power analysis attack.

Using the same examples with the intermediate-state, switching between the 1-of-4 codewords 0100 to 1000 would involve de-activating one line to enter the intermediate-state of 0000, and then activating one line to achieve the codeword 1000. Similarly, switching between the 1-of-4 codewords 0100 to 0100 would also involve de-activating one line to enter the intermediate-state of 0000, and then activating one line to achieve the codeword 0100. In other words, the same number of switching events occurs when the intermediate-state is used regardless of whether successive codewords are the same or are different. This improves the hardware implementation's resistance to power analysis attacks.

It will be appreciated that the use of the all-zero codeword 00 . . . 0 as the intermediate-state involves using a meaningless codeword, as none of the n-of-m codewords are formed using m 0-bits. Additionally, other sequence of bits, such as 11 . . . 1 (i.e. m 1's) may be used for the intermediate state, provided that switching to/from any n-of-m codeword that is used for data to the value used for the intermediate state involves a fixed number of lines being activated and deactivated. When the value of 00 . . . 0 is used for the intermediate state, the intermediate state may be known as a zero-state.

FIGS. 4a-c schematically illustrate logic circuits for implementing the zero-state when an n-of-4 representation is being used, although it will be appreciated that other circuits could be used for achieving the same effect. Additionally, it will be appreciated that these circuits scale linearly with the size of m for the n-of-m representations.

In each of these figures, the next n-of-4 codeword to be output is a₃a₂a₁a₀, whilst the actual values output on the 4 lines for the codeword are q₃q₂q₁q₀. A control signal Cntrl is used that alternates between a high value when the intermediate-state (fixed state) is to be entered and a low value when the next codeword is to be output.

FIG. 4a illustrates the overall logic circuit to be achieved for implementing the zero-state. Each of the values aᵢ is inverted and applied at an input of a corresponding 2-input NOR gate, the other input to the NOR gate being the control signal Cntrl. This achieves a low output when the control signal Cntrl is high (i.e. during the zero-state) and an output of aᵢ when the control signal is low (i.e. during a computation cycle).

FIG. 4b illustrates an implementation of the circuit of FIG. 4a when registers 400 are used to store the values of aᵢ. A clock signal Clk, matching the control signal Cntrl, is used to control the output from the registers 400. In FIG. 4b, the registers 400 do not themselves store the zero-sate word 00 . . . 0.

FIG. 4c illustrates another implementation of the circuit of FIG. 4a when registers 402, 404 are used to store the values of aᵢ and the zero-state word 00 . . . 0. A clock signal Clk is used, with the control signal Cntrl being half the frequency of the clock signal Clk. A first set of four registers 402 stores respective aᵢ values. The clock signal Clk is used to control the output from the registers 402 to corresponding registers 404 in a second set of four registers 404. The clock signal Clk is also used to control the output from the registers 404 to form the output value q₃q₂q₁q₀. In this way, the four registers 404 alternatively store the values of aᵢ (for the computation cycle) and 0-bits (for the fixed-state).

In FIG. 4d illustrates an alternative implementation of the circuit of FIG. 4b in which two sets of registers 406, 408 are used to store alternate/sequential n-of-m codewords. A clock signal Clk is used, with the control signal Cntrl being half the frequency of the clock signal Clk. When the value of the clock signal Clk is high, the inverted output of the gates 410 is low, so that a zero-state is produced and output by a multiplexer 412. When the value of the clock signal Clk is low, the sets of registers 406, 408 output their values to the gates 410, which are arranged to pass these values to the multiplexer 412. When the control signal Cntrl is high (during which time the clock signal Clk will first have been high and then low), the second set of registers 408 is reset and the multiplexer 412 will output the values from the first set of registers 406. When the control signal Cntrl is low (during which time the clock signal Clk will first have been high and then low), the first set of registers 406 is reset and the multiplexer 412 will output the values from the first set of registers 408. The use of the double set of registers 406, 408, together with their resetting, helps prevent the hamming weight of successive codewords being leaked to an attacker.

As discussed above, processing data in an n-of-m format can help make the power consumption of an implementation of a cryptographic algorithm (at the step S302) less data dependent.

To make the power consumption of an implementation of the cryptographic algorithm (at the step S302) even less data dependent, embodiments of the invention may make use of power balanced logic structures (or logic circuits). A power balanced logic structure is a logic circuit that comprises logic gates arranged such that the logic circuit consumes substantially the same amount of power for all possible combinations of valid inputs to the logic circuit. It may receive as an input one or more n₁-of-m₁ codewords and may output one or more n₂-of-m₂ codewords. Its power consumption is substantially the same for all possible combinations of inputs and outputs, regardless of the physical implementation of the gates used for the logic circuit. The logic circuit illustrated in FIG. 2a is a power balanced logic structure for the following reasons. For each output value aᵢ and bᵢ, the logic path to generate that output value is formed from a single 2-input OR gate, so that every output path is a mirror of every other output path. As the input is only ever a 1-of-4 codeword q₃q₂q₁q₀, only one of the qᵢ will be a 1, with the rest being a 0. As such, for each possible input to this logic circuit, two out of the four OR gates will consume power to produce a high output voltage, whilst the other two of the four OR gates will consume power to produce a low output voltage, i.e. the same total power is consumed no matter what the input/output codewords are.

Similarly, the logic circuit illustrated in FIG. 2b is a power balanced logic structure for the following reasons. For each output value qᵢ, the logic path to generate that output value is formed from a single 2-input AND gate, so that every output path is a mirror of every other output path. As the input is a pair of 1-of-2 codewords a₁a₀ and b₁b₀, only one of the aᵢ will be a 1, with other being a 0, and only one of the bᵢ will be a 1, with other being a 0. As such, for each possible input to this logic circuit, only one out of the four AND gates will consume power to produce a high output voltage, whilst the other three of the four AND gates will consume power to produce a low output voltage, i.e. the same total power is consumed no matter what the input/output codewords are.

It will be appreciated that the power balanced nature of a logic structure results, in part at least, from the knowledge that the input data to the logic structure is one or more n-of-m codewords, i.e. there will be a predetermined number of input lines that will be high and a predetermined number of input lines that will be low.

Additionally, for some logic structures, power balancing will be achieved through the actual arrangement and use of particular logic gates, to ensure that all logic paths of the logic structure will use the same amount of power for all possible input data. Sometimes, as will be discussed in more detail later, dummy logic gates may be introduced to achieve the power balancing, in an operation called circuit matching. The dummy gates are logic gates (such as AND or OR gates) that do not actually contribute to the output of the logic structure, but simply take ground level (or maybe even high level) inputs and are present to ensure that all logic paths through the logic structure consume the same power for all possible inputs to the logic structure.

If a logic structure is built up as a construct of other power balanced logic structures, then the logic structure that is built up will itself inherently also be power balanced.

### 6) Error Detection and Fault-Injection Attacks

Error detection can be implemented at various stages of a cryptographic algorithm. For example, the AES128 algorithm described in section 11 below has 10 rounds, and error detection can be implemented at the end of each round. The Camellia-128 algorithm described in section 12 below has 18 rounds, and error detection can be implemented at the end of each round. However, error detection may be implemented simply at the end of the cryptographic algorithm, i.e. on the final output. Alternatively, error detection may be implemented after each fundamental operation, for example, after adding or multiplying two elements of GF(2²) together. The skilled person will therefore appreciate that error detection may be performed once or multiple times for an implementation of a cryptographic process, and that the error detection may be performed at any stage during the cryptographic process.

The use of n-of-m codewords for processing the cryptographic algorithm facilitates error-detection at a relatively low implementation cost. For each n-of-m codeword, the number of bits that are asserted (1-bits) and the number of bits that are not asserted (0-bits) are fixed. Thus, for an even value of n, the number of 1-bits is always even and for an odd-value of n, the number of 1-bits is always odd. Hence some embodiments of the invention may perform error detection by performing a parity check on each n-of-m codeword. If n is even and the parity of a codeword is determined to be odd, then an error is detected; if n is odd and the parity of a codeword is determined to be even, then an error is detected.

Alternatively, in some embodiments of the invention, for each codeword, the number of 1-bits are counted. If this number is different to n, then that codeword is not an n-of-m codeword and hence an error has been detected. Similarly, in some embodiments of the invention, for each codeword, the number of 0-bits are counted. If this number is different to m-n, then that codeword is not an n-of-m codeword and hence an error has been detected.

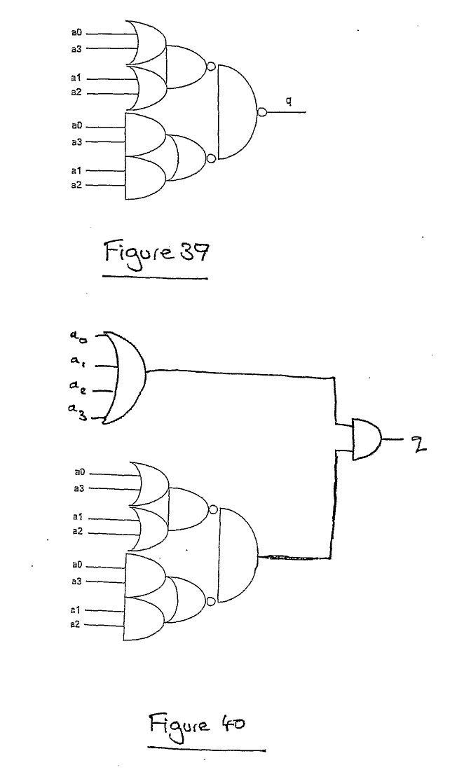

In an alternative embodiment of the invention, a checker is used to determine whether a codeword is an n-of-m codeword. An example 1-of-4 checker is illustrated schematically in FIG. 39. The output of this checker, q, is 0 unless 2 or more wires of the input data word a₃a₂a₁a₀ are high. Hence, if q is output as 1, then an error has been detected as the input data word should be a 1-of-4 codeword having only one wire high. FIG. 40 schematically illustrates an alternative 1-of-4 checker, whose output value q is a 1 only if the input data word a₃a₂a₁a₀ is a 1-of-4 codeword.

As an alternative, an embodiment of the invention may implement the cryptographic algorithm multiple times in parallel. For example, a cryptographic algorithm may be implemented twice. The data at various stages of the processing of one implementation may be compared to the data at the same stages in the other implementation. In this way, if an error is introduced into one implementation, but not the other, then the comparison of the data between the two implementations would indicate that an error has been introduced. Example 1-of-4 comparators are described later in section 10.4. It will be appreciated that this comparison applies equally to other n-of-m formats and to systems that implement more than two embodiments of the cryptographic algorithm. For example, if three embodiments of the cryptographic algorithm are implemented, then the first one could be compared to the second one, and the second one compared to the third one. Alternatively, each embodiment could be compared to every other embodiment.

As can be see, the use of the n-of-m codewords facilitates error detection and can, itself, be the basis of the actual error detection itself, given the predetermined number of 1-bits and 0-bits per codeword. In this way, detection of fault-attacks can be performed.

If an error is detected, then various measures may be taken, such as the cryptographic device performing a self-destruct or data erasure.

7) Selection of n and m for the n-of-m Codewords

The particular choice of n and m to use for the n-of-m format depends on several factors and many different combinations of n and m may be available for representing elements of a particular Galois field. For example, elements of GF(2³) may be represented by 1-of-8, 2-of-6 and 2-of-5 codewords.

Naturally, for a given value of m, the lower the value of n, the less power the hardware implementation might use as fewer lines need to be active at any point in time. For example, a 1-of-4 representation can represent as many bits as a 3-of-4 representation, but would consume less power: in the 1-of-4 representation, 25% of the wires evaluate (i.e. consumer higher power) whilst in the 3-of-4 representation, 75% of the wires evaluate.

However, values of n closer to m/2 can increase the number of binary bits that can be represented by a single n-of-m representation. For example, the number of bits that can be represented by a single 3-of-8 representation is 5, whilst the number of bits that can be represented by a single 4-of-8 representation is 6. Hence, for some applications, a slightly higher value of n may be more suitable. Furthermore, as will be appreciated, the larger the value of m, the more binary data bits can be represented by a single n-of-m codeword. However, the amount of hardware required as the values of m and n increase may also increase.

The efficiency of an n-of-m format can be defined by two metrics: rate Ra and redundancy Re as defined below:

$$Ra = \frac{{log}_{2} {m}_{s}}{m} and Re = m - {log}_{2} {m}_{s}$$

where mₛ is the number of discrete symbols that can be represented by an n-of-m codeword.

In general, it is desirable to maximize the rate Ra and minimize the redundancy Re. However, power consumption levels play a part in the decision for the values of n and m.

The 2-of-4 format has a rate of 0.65 and a redundancy of 1.42 whilst the 1-of-4 format has a rate of 0.5 and a redundancy of 2. However, the 2-of-4 format requires twice the power consumption as the 1-of-4 format. Hence, the 1-of-4 representation strikes a good balance between low power consumption, a small hardware requirement and a sufficiently large data representation capability. However, it will be appreciated that embodiments of the invention may make use of any n-of-m representation.

8) Example Operations in GF(2) Using a 1-of-2 Representation

Described below are a number of example operations that can be performed using the arithmetic of GF(2) when the data is to be processed in a 1-of-2 representation. It will be appreciated that other logic circuits could be used to implement these example operations and that many more operations exist that could also be implemented analogously using a 1-of-2 representation. Additionally, other operations in GF(2^{r}) could be implemented analogously using a 1-of-2 representation.

A logical XOR table for logically XOR-ing two elements a and b of GF(2), with elements represented by 1-of-2 codewords (using the mapping of table 3), is given in table 7 below.

TABLE 7

a = a₁a₀

| | | |
|---|---|---|
| a XOR b | 01 | 10 |

| | | | |
|---|---|---|---|
| b = b₁b₀ | 01 | 01 | 10 |
| | 10 | 10 | 01 |

As mentioned above, FIG. 6a schematically illustrates a power-balanced logic circuit implementing a GF(2) logical XOR, where the data is represented using the 1-of-2 codewords. It also provides a set of Boolean logic equations for the logical XOR operation, which are implemented in the logic circuit shown in FIG. 6a.

A logical AND table for logically AND-ing two elements a and b of GF(2), with elements represented by 1-of-2 codewords (using the mapping of table 3), is given in table 8 below.

TABLE 8

a = a₁a₀

| | | |
|---|---|---|
| a AND b | 01 | 10 |

| | | | |
|---|---|---|---|
| b = b₁b₀ | 01 | 01 | 01 |
| | 10 | 01 | 10 |

FIG. 6b schematically illustrates a logic circuit implementing a GF(2) logical AND, where the data is represented using the 1-of-2 codewords. It also provides a first set of minimized Boolean logic equations for the logical AND operation, which are implemented in the logic circuit shown in FIG. 6b. This figure also provides a second set of Boolean logic equations which have been power balanced (using dummy logic gates) and could therefore be implemented as a power-balanced logic circuit for implementing a GF(2) logical AND.

A logical OR table for logically OR-ing two elements a and b of GF(2), with elements represented by 1-of-2 codewords (using the mapping of table 3), is given in table 9 below.

TABLE 9

a = a₁a₀

| | | |
|---|---|---|
| a OR b | 01 | 10 |

| | | | |
|---|---|---|---|
| b = b₁b₀ | 01 | 01 | 10 |
| | 10 | 01 | 10 |

FIG. 6c schematically illustrates a logic circuit implementing a GF(2) logical OR, where the data is represented using the 1-of-2 codewords. It also provides a first set of minimized Boolean logic equations for the logical OR operation, which are implemented in the logic circuit shown in FIG. 6c. This figure also provides a second set of Boolean logic equations which have been power balanced (using dummy logic gates) and could therefore be implemented as a power-balanced logic circuit for implementing a GF(2) logical OR.

9) Example Operations in GF(2^{r}) Using a 1-of-4 Representation

Described below are a number of example operations that can be performed using the arithmetic of GF(2^{r}) when the data is to be processed in a 1-of-4 representation. As will be discussed, some of the example logic circuits shown are power balanced. It will be appreciated that other power balanced logic circuits could be used to implement these example operations and that many more operations exist that could also be implemented analogously in power balanced circuits using a 1-of-4 representation. Additionally, the general principles illustrated in the follow examples are equally applicable to the more general n-of-m representation.

As illustrated below, operations performed on GF(2⁴), GF(2⁸), etc. can be implemented based on underlying GF(2²) operations as appropriate. When the GF(2²) logic circuits used are power balanced, the logic circuits for GF(2⁴), GF(2⁸), etc. operations that are built from the power balanced GF(2²) logic circuits will also be power balanced.

It will be appreciated though that embodiments of the invention may make use of non-power-balanced logic circuits. This may be particularly useful and applicable to situations in which the amount of hardware has to be kept to a minimum, as power-balanced logic circuits can sometime involve the use of more hardware (logic gates) than functionally equivalent non-power-balanced logic circuits.

9.1) Addition in GF(2²) and 1-of-4 GF(2²) Adder

As is well-known, addition of two elements of GF(2²) amounts to addition of the polynomial representation of the elements, with the resulting polynomial coefficients being modulo 2, i.e. a polynomial in GF(2)[x]. Table 10 below is then an appropriate addition table for GF(2²)

TABLE 10

| + | 0 | 1 | x | x + 1 |
|---|---|---|---|---|
| 0 | 0 | 1 | x | x + 1 |
| 1 | 1 | 0 | x + 1 | x |
| x | x | x + 1 | 0 | 1 |
| x + 1 | x + 1 | x | 1 | 0 |

A corresponding addition table for GF(2²) with elements represented by 1-of-4 codewords (using the mapping of table 5) is given in table 11 below.

TABLE 11

a = a₃a₂a₁a₀

| | | | | |
|---|---|---|---|---|
| a + b | 0001 | 0010 | 0100 | 1000 |

| | | | | | |
|---|---|---|---|---|---|
| b = b₃b₂b₁b₀ | 0001 | 0001 | 0010 | 0100 | 1000 |
| | 0010 | 0010 | 0001 | 1000 | 0100 |
| | 0100 | 0100 | 1000 | 0001 | 0010 |
| | 1000 | 1000 | 0100 | 0010 | 0001 |

From table 11, is it clear that two elements of GF(2²) in the 1-of-4 format, namely a₃a₂a₁a₀ and b₃b₂b₁b₀ can be added to produce the output 1-of-4 codeword q₃q₂q₁q₀ using the following logic equations (Boolean binary equations):

q₀=(a₀·b₀)+(a₁·b₁)+(a₂·b₂)+(a₃·b₃)

q₁=(a₀·b₁)+(a₁·b₀)+(a₂·b₃)+(a₃·b₂)

q₂=(a₀·b₂)+(a₁·b₃)+(a₂·b₀)+(a₃·b₁)

q₃=(a₀·b₃)+(a₁·b₂)+(a₂·b₁)+(a₃·b₀)

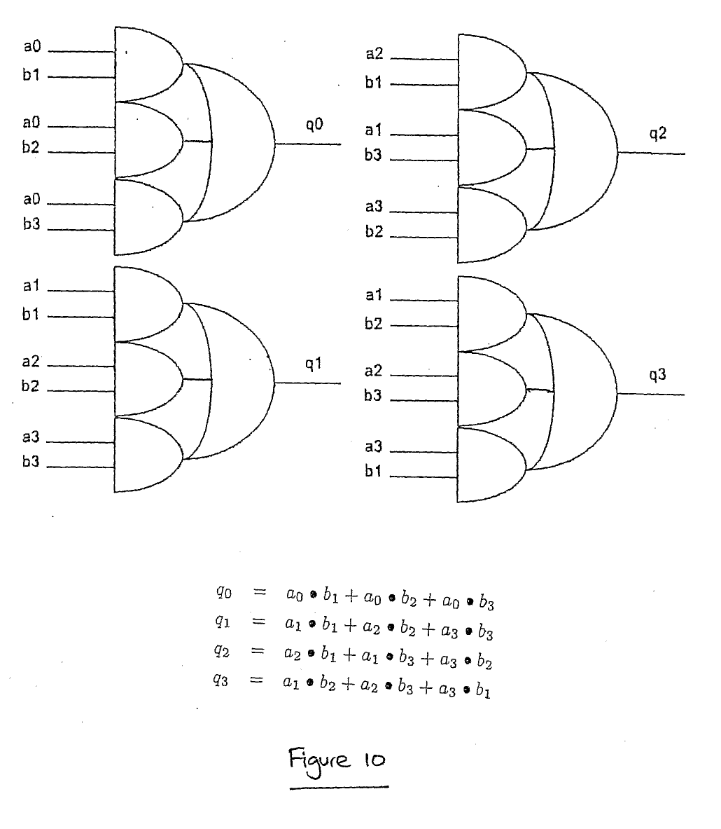

FIG. 7 schematically illustrates a logic circuit implementing GF(2²) addition, where the data is represented using the 1-of-4 codewords. This logic circuit implements the above-described addition in GF(2²) using the above logic equations. It will be appreciated, though, that the same result could be produced by differently implemented logic circuits as appropriate.

In FIG. 7, each output q₁ is formed using four 2-input AND gates, the outputs of which are fed to one 4-input OR gate. Thus, every output path is a mirror of every other output path. As the inputs are only ever 1-of-4 codewords a₃a₂a₁a₀ and b₃b₂b₁b₀, only one of the aᵢ and one of the bᵢ will be a 1, with the rest of the aᵢ and bᵢ being a 0. As such, for every possible input to this logic circuit, only one of the sixteen AND gates will consume power to produce a high output voltage, whilst the other fifteen of the sixteen AND gates will consume power to produce a low output voltage. Consequently, for every possible input to this logic circuit, only one of the four OR gates will consume power to produce a high output voltage, whilst the other three of the four OR gates will consume power to produce a low output voltage. As a result, the same total power is consumed no matter what the input/output codewords are, i.e. this logic circuit is a power balanced logic structure.

To perform addition by a (non-zero) constant value, appropriate swapping of lines/wires can be performed to achieve the required addition. This appropriate wire swapping is derived from table 11. For example, adding the constant 0010 to a₃a₂a₁a₀ can be implemented by simply swapping the wires representing a₀ and a₁ and swapping the wires representing a₂ and a₃. Naturally, there is no need to perform constant addition by 0 as this does not affect the data.

### 9.2) Subtraction in GF(2²)

Subtraction in GF(2²) is the same way as addition in GF(2²) (as −1 modulo 2=1). Hence subtraction can be implemented using the 1-of-4 GF(2²) adder discussed above.

9.3) Multiplication in GF(2²) and 1-of-4 GF(2²) Multiplier

As is well-known, multiplication of two elements of GF(2²) amounts to multiplication of the polynomial representation of the elements modulo the irreducible polynomial x²+x+1, with the resulting polynomial coefficients being modulo 2, i.e. a polynomial in GF(2)[x]. Table 12 below is then an appropriate multiplication table for GF(2²).

TABLE 12

| * | 0 | 1 | x | x + 1 |
|---|---|---|---|---|
| 0 | 0 | 0 | 0 | 0 |
| 1 | 0 | 1 | x | x + 1 |
| x | 0 | x | x + 1 | 1 |
| x + 1 | 0 | x + 1 | 1 | x |

A corresponding multiplication table for GF(2²) with elements represented by 1-of-4 codewords (using the mapping of table 5) is given in table 13 below.

TABLE 13

a = a₃a₂a₁a₀

| | | | | |
|---|---|---|---|---|
| a*b | 0001 | 0010 | 0100 | 1000 |

| | | | | | |
|---|---|---|---|---|---|
| b = b₃b₂b₁b₀ | 0001 | 0001 | 0001 | 0001 | 0001 |
| | 0010 | 0001 | 0010 | 0100 | 1000 |
| | 0100 | 0001 | 0100 | 1000 | 0010 |
| | 1000 | 0001 | 1000 | 0010 | 0100 |

From table 13, it is clear that two elements of GF(2²) in the 1-of-4 format, namely a₃a₂a₁a₀ and b₃b₂b₁b₀ can be multiplied to produce the output 1-of-4 codeword q₃q₂q₁q₀ using the following logic equations:

q₀=a₀+b₀

q₁=(a₁·b₁)+(a₂·b₃)+(a₃·b₂)

q₂=(a₁·b₂)+(a₂·b₁)+(a₃·b₃)

q₃=(a₁·b₃)+(a₂·b₂)+(a₃·b₁)

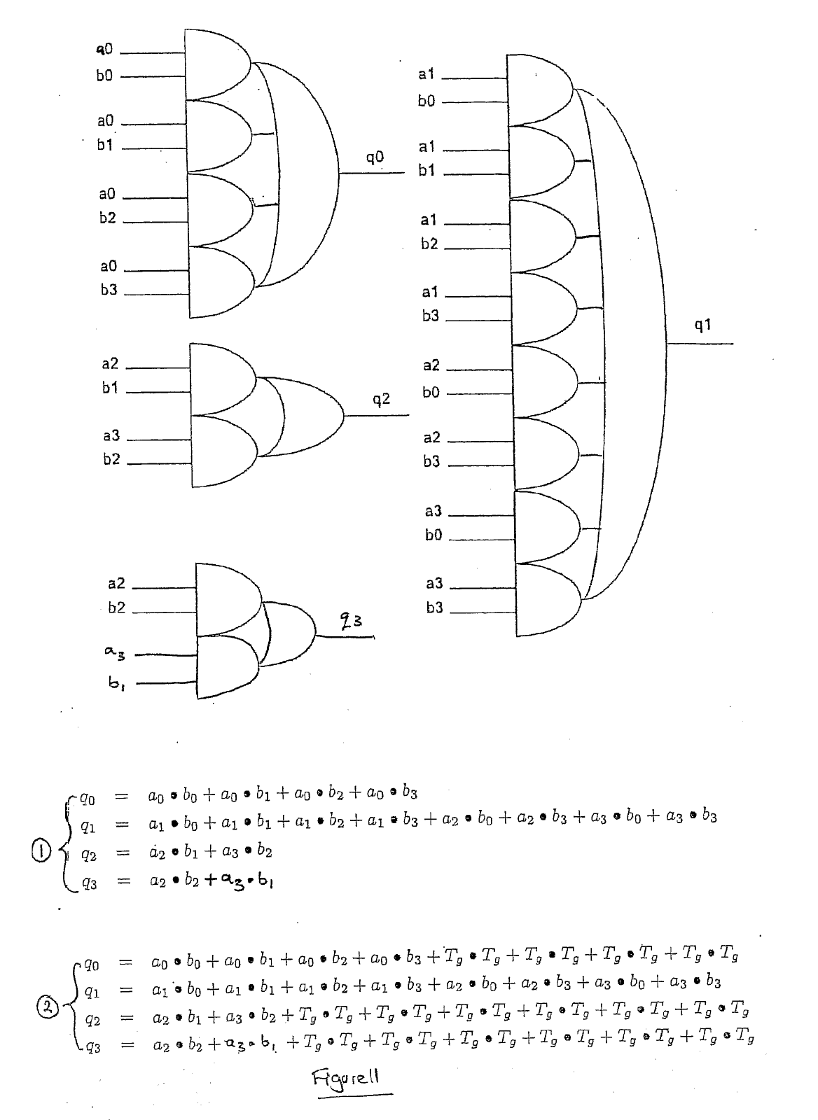

FIG. 8 schematically illustrates a logic circuit implementing GF(2²) multiplication, where the data is represented using the 1-of-4 codewords, using the above logic equations. Calculation of q₀ involves one 2-input OR gate and calculation of each of q₁, q₂ and q₃ involves three 2-input AND gates and one 3-input OR gate. However, this logic structure is not power balanced. For example, an input of a₃a₂a₁a₀=0001 and b₃b₂b₁b₀=0001 would result in the one 2-input OR gate consuming power to produce a high output voltage and the nine 2-input AND gates and three 3-input OR gates consuming power to produce a low output voltage. In contrast, an input of a₃a₂a₁a₀=0010 and b₃b₂b₁b₀=0010 would result in one of the 2-input AND gates and one of the 3-input OR gates consuming power to produce a high output voltage and the 2-input OR gate, eight of the 2-input AND gates and two of the 3-input OR gates consuming power to produce a low output voltage. Hence the logic circuit of FIG. 8 is not power balanced.

Therefore embodiments of the invention may use the following alternative logic equations to calculate the values of q₁:

q₀=(a₀·b₀)+(a₀·b₁)+(a₀·b₂)+(a₀·b₃)+(a₁·b₀)+(a₂·b₀)+(a₃·b₀)

q₁=(a₁·b₁)+(a₂·b₃)+(a₃·b₂)+(T_{g}·T_{g})+(T_{g}·T_{g})+(T_{g}·T_{g})+(T_{g}·T_{g})

q₂=(a₁·b₂)+(a₂·b₁)+(a₃·b₃)+(T_{g}·T_{g})+(T_{g}·T_{g})+(T_{g}·T_{g})+(T_{g}·T_{g})

q₃=(a₁·b₃)+(a₂·b₂)+(a₃·b₁)+(T_{g}·T_{g})+(T_{g}·T_{g})+(T_{g}·T_{g})+(T_{g}·T_{g})

where T_{g} is a ground (low) level input (i.e. logic-zero).

FIG. 9 schematically illustrates a logic circuit implementing GF(2²) multiplication, where the data is represented using the 1-of-4 codewords. This logic circuit implements the above-described multiplication in GF(2²) using the above logic equations. It will be appreciated, though, that the same result could be produced by differently implemented logic circuits as appropriate.

In FIG. 9, each output q₁ is formed using seven 2-input AND gates, the outputs of which are fed to one 7-input OR gate. Thus, every output path is a mirror of every other output path. As the inputs are only ever 1-of-4 codewords a₃a₂a₁a₀ and b₃b₂b₁b₀, only one of the aᵢ and one of the bᵢ will be a 1, with the rest of the aᵢ and bᵢ being a 0. As such, for every possible input to this logic circuit, only one of the twenty-eight AND gates will consume power to produce a high output voltage, whilst the other twenty-seven of the twenty-eight AND gates will consume power to produce a low output voltage. Consequently, for every possible input to this logic circuit, only one of the four OR gates will consume power to produce a high output voltage, whilst the other three of the four OR gates will consume power to produce a low output voltage. As a result, the same total power is consumed no matter what the input/output codewords are, i.e. this logic circuit is a power balanced logic structure.

As can be seen, in FIG. 9 dummy AND gates have been introduced. These AND gates take at their inputs the ground level input T_{g} and hence will always output a low voltage, consuming the same amount of power regardless of the input to the GF(2²) multiplier. However, they have been introduced to increase the amount of power consumed for the q₁, q₂ and q₃ calculation paths, so that these calculation paths mirror the calculation path of q₀.

FIG. 9 illustrates a specific example of the use of dummy logic gates. When trying to power balance other logic structures, dummy logic gates could be used of any type (e.g. AND, OR, NOR, XOR, NAND, etc.) as appropriate to ensure that each logic path in the logic structure will always consume the same amount of power, regardless of the inputs to and output from the logic structure.

To perform multiplication by a (non-zero and non-one) constant value, appropriate swapping of lines/wires can be performed to achieve the required multiplication. This appropriate wire swapping is derived from table 13. For example, multiplication of a₃a₂a₁a₀ by the constant 0100 can be implemented by simply swapping the wires for a₁, a₂ and a₃ so that the wire for a₁ becomes the wire for a₂, the wire for a₂ becomes the wire for a₃ and the wire for a₃ becomes the wire for a₁. Naturally, there is no need to perform constant multiplication by 1 as this does not affect the data. Constant multiplication by 0 can be implemented by setting the lines for the output data to represent 0001, e.g. by using a four-input OR gate receiving the input codeword a₃a₂a₁a₀ to always produce a 1 for the output q₀, with the other output values q₁, q₂ and q₃ being hardwired to ground level.

### 9.4) Other GF(2²) Operations

A division table for dividing an element a of GF(2²) by a non-zero element b of GF(2²), with elements represented by 1-of-4 codewords (using the mapping of table 5), is given in table 14 below.

TABLE 14

a = a₃a₂a₁a₀

| | | | | |
|---|---|---|---|---|
| a/b | 0001 | 0010 | 0100 | 1000 |

| | | | | | |
|---|---|---|---|---|---|
| b = b₃b₂b₁b₀ | 0010 | 0001 | 0010 | 0100 | 1000 |
| | 0100 | 0001 | 1000 | 0010 | 0100 |
| | 1000 | 0001 | 0100 | 1000 | 0010 |

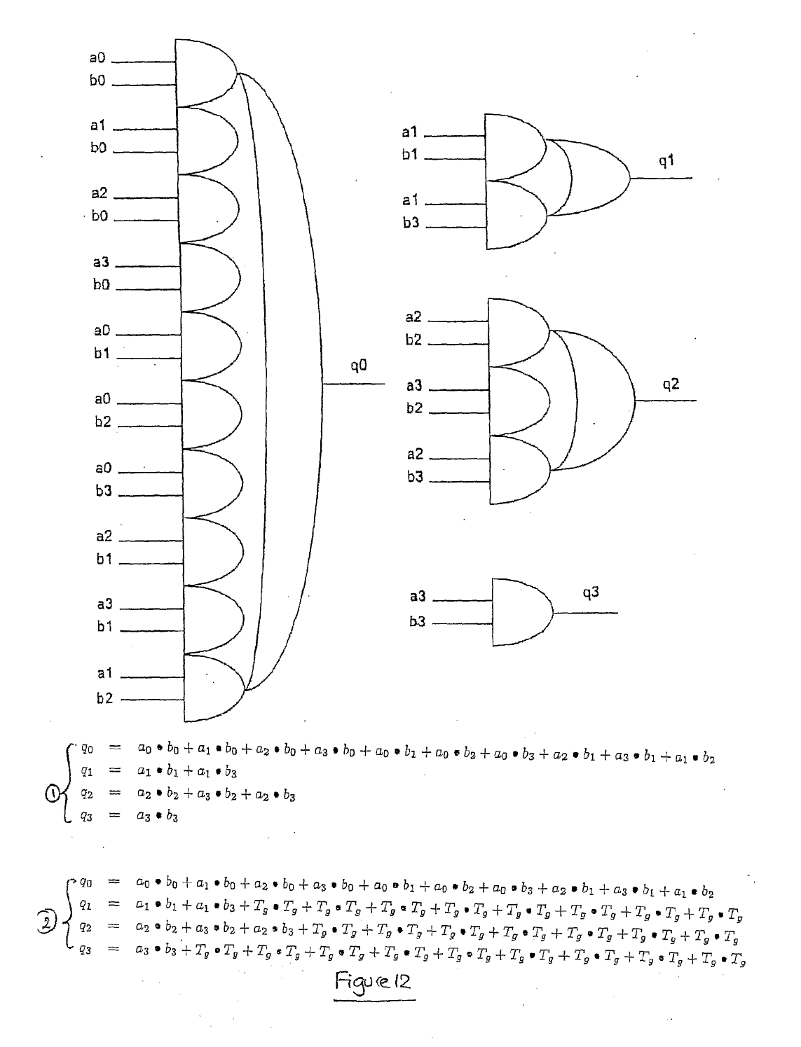

FIG. 10 schematically illustrates a power-balanced logic circuit implementing GF(2²) division, where the data is represented using the 1-of-4 codewords. It also provides the Boolean logic equations for the division operation.

An exponentiation table for raising an element a of GF(2²) to the power of an element b of GF(2²), with elements represented by 1-of-4 codewords (using the mapping of table 5), is given in table 15 below.

TABLE 15

a = a₃a₂a₁a₀

| | | | | |
|---|---|---|---|---|
| a^{b} | 0001 | 0010 | 0100 | 1000 |

| | | | | | |
|---|---|---|---|---|---|
| b = b₃b₂b₁b₀ | 0001 | 0001 | 0010 | 0010 | 0010 |
| | 0010 | 0001 | 0010 | 0100 | 1000 |
| | 0100 | 0001 | 0010 | 1000 | 0100 |
| | 1000 | 0001 | 0010 | 0010 | 0010 |

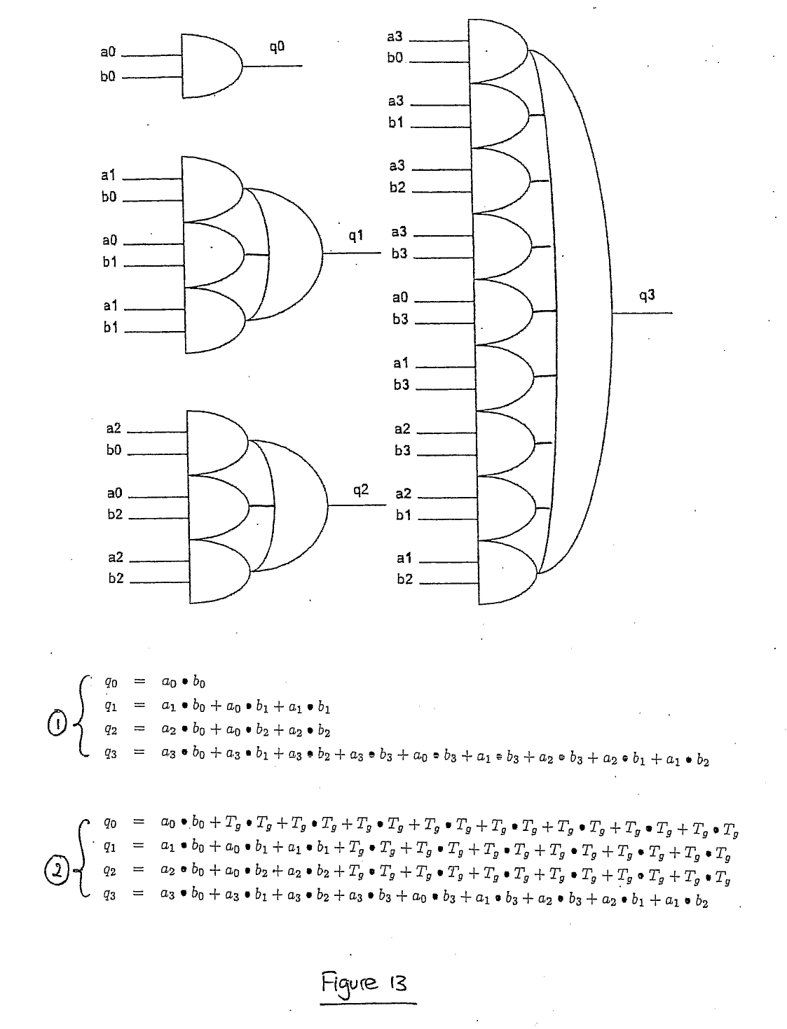

FIG. 11 schematically illustrates a logic circuit implementing GF(2²) exponentiation, where the data is represented using the 1-of-4 codewords. It also provides a first set of minimized Boolean logic equations for the division operation, which are implemented in the logic circuit shown in FIG. 11. This figure also provides a second set of Boolean logic equations which have been power balanced (using dummy logic gates) and could therefore be implemented as a power-balanced logic circuit for implementing GF(2²) exponentiation.

Table 16 below illustrates how an inverse of an element a of GF(2²) can be determined and how the logarithm of an element a of GF(2²) can be determined, with elements represented by 1-of-4 codewords (using the mapping of table 5).

TABLE 16

| a = a₃a₂a₁a₀ | a⁻¹ | log(a) |
|---|---|---|
| 0001 | 0001 | N/A |
| 0010 | 0010 | 0001 |
| 0100 | 1000 | 0010 |
| 1000 | 0100 | 0100 |

In similar way to which constant multiplication and constant addition can be implemented by swapping wires, the calculation of the inverse or the logarithm of an element of GF(2²) can also be implemented by swapping the wires representing the value of a=a₃a₂a₁a₀.

A logical AND table for logically AND-ing two elements a and b of GF(2²), with elements represented by 1-of-4 codewords (using the mapping of table 5), is given in table 17 below.

TABLE 17

a = a₃a₂a₁a₀

| | | | | |
|---|---|---|---|---|
| a AND b | 0001 | 0010 | 0100 | 1000 |

| | | | | | |
|---|---|---|---|---|---|
| b = b₃b₂b₁b₀ | 0001 | 0001 | 0001 | 0001 | 0001 |
| | 0010 | 0001 | 0010 | 0001 | 0001 |
| | 0100 | 0001 | 0001 | 0100 | 0100 |
| | 1000 | 0001 | 0010 | 0100 | 1000 |

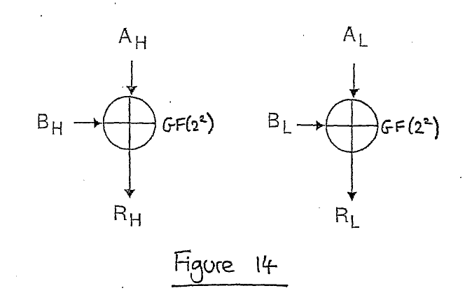

FIG. 12 schematically illustrates a logic circuit implementing a GF(2²) logical AND, where the data is represented using the 1-of-4 codewords. It also provides a first set of minimized Boolean logic equations for the logical AND operation, which are implemented in the logic circuit shown in FIG. 12. This figure also provides a second set of Boolean logic equations which have been power balanced (using dummy logic gates) and could therefore be implemented as a power-balanced logic circuit for implementing a GF(2²) logical AND.

A logical OR table for logically OR-ing two elements a and b of GF(2²), with elements represented by 1-of-4 codewords (using the mapping of table 5), is given in table 18 below.

TABLE 18

a = a₃a₂a₁a₀

| | | | | |
|---|---|---|---|---|
| a OR b | 0001 | 0010 | 0100 | 1000 |

| | | | | | |
|---|---|---|---|---|---|
| b = b₃b₂b₁b₀ | 0001 | 0001 | 0010 | 0100 | 1000 |
| | 0010 | 0010 | 0010 | 1000 | 1000 |
| | 0100 | 0100 | 1000 | 0100 | 1000 |
| | 1000 | 1000 | 1000 | 1000 | 1000 |

FIG. 13 schematically illustrates a logic circuit implementing a GF(2²) logical OR, where the data is represented using the 1-of-4 codewords. It also provides a first set of minimized Boolean logic equations for the logical OR operation, which are implemented in the logic circuit shown in FIG. 13. This figure also provides a second set of Boolean logic equations which have been power balanced (using dummy logic gates) and could therefore be implemented as a power-balanced logic circuit for implementing a GF(2²) logical OR.

Table 19 below illustrates how a logical NOT of an element a of GF(2²) can be determined, with elements represented by 1-of-4 codewords (using the mapping of table 5).

TABLE 19

| a = a₃a₂a₁a₀ | NOT a |
|---|---|
| 0001 | 1000 |
| 0010 | 0100 |
| 0100 | 0010 |
| 1000 | 0001 |

In similar way to which constant multiplication and constant addition can be implemented by swapping wires, the logical NOT can also be implemented by swapping the wires representing the value of a=a₃a₂a₁a₀.

9.5) Addition in GF(2⁴) and 1-of-4 GF(2⁴) Adder

As discussed above, elements a and b of GF(2⁴) can be represented respectively by the polynomials aₕx+aₗ and bₕx+bₗ where aₕ, aₗbₕ, bₗεGF(2²). Hence, a+b=(aₕ+bₕ)x+(aₗ+bₗ).

Thus addition of elements a and b of GF(2⁴) can be achieved by:

(i) transforming a and b to their respective representations aₕx+aₗ and bₕx+bₗ (using the above-mentioned isomorphism and implementations thereof); then

(ii) performing addition using the above-mentioned GF(2²) adders to yield rₕ=(aₕ+bₕ) and rₗ=(aₗ+bₗ); and then

(iii) transforming the tuple rₕ, rₗ back from a pair of GF(2²) elements to a single GF(2⁴) element (using the inverse of the above-mentioned isomorphism and implementations thereof).

It will be appreciated that it may not always be necessary to perform the above steps (i) and/or (iii). For example, the step (i) can be omitted if the input data is already in the form of tuples of elements of GF(2²) (e.g. from the step S500). Additionally, the step (iii) can be omitted if the output data is to be converted elsewhere back to a different field, (e.g. at the step S504). Additionally, the above steps (i) and (iii) may be omitted if two operations, implemented based on GF(2²) operators, are to be performed back-to-back. For example, if two of the above GF(2⁴) addition operators are to be implemented back-to-back, then the first one may omit the step (iii) and the second one may omit the step (i) (at least in respect of the output from the first operator).

It will be appreciated that, in general, a GF(2^{k}) adder (where k=rs) for adding together two elements a and b of GF(2^{k}) can be implemented by:

(i) transforming a and b to their respective representations as s-tuples of elements of GF(2^{r}) (using the above-mentioned isomorphism and the implementation thereof); then

(ii) performing addition on corresponding elements of the two s-tuples using s GF(2^{r}) adders to yield a single s-tuple of elements of GF(2^{r}); and then

(iii) transforming the s-tuple of elements of GF(2^{r}) produced at step (ii) back to a single GF(2^{k}) element (using the inverse of the above-mentioned isomorphism and the implementation thereof).

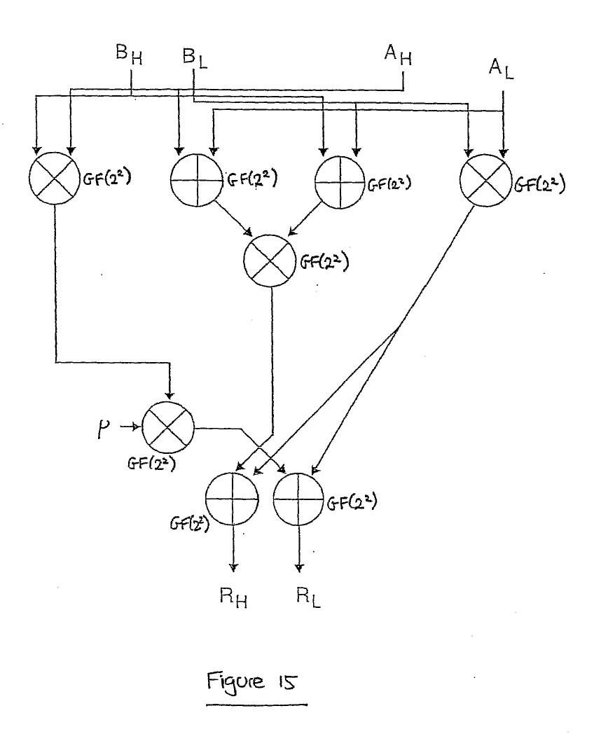

FIG. 14 schematically illustrates a logic circuit for performing GF(2⁴) addition using the GF(2²) adders of FIG. 7. As the above steps (i) and (iii) are optional, these have been omitted from FIG. 14.

9.6) Multiplication in GF(2⁴) and 1-of-4 GF(2⁴) Multiplier

As discussed above, elements a and b of GF(2⁴) can be represented respectively by the polynomials aₕx+aₗ and bₕx+bₗ where aₕ, aₗ, bₕ, bₗεGF(2²). Hence, a*b=(aₕ*bₕ)x²+(aₕ*bₗ+aₗ*bₕ)x+(aₗ*bₗ) mod P(x), where P(x) is the irreducible polynomial used to obtain the extension field GF(2⁴)=GF((2²)²) from GF(2²). Using the above-mentioned polynomial of P(x)=x²+x+μ, we have that a*b=(aₕ*bₕ)(x+μ)+(aₕ*bₗ+aₗ*bₕ)x+(aₗ*bₗ), so that a*b=(aₕ*bₗ+aₗ*bₕ+aₕ*bₕ)x+(aₗ*bₗ+aₕ*bₕ*μ).

Thus addition of elements a and b of GF(2⁴) can be achieved by:

(i) transforming a and b to their respective representations aₕx+aₗ and bₕx+bₗ (using the above-mentioned isomorphism and implementations thereof); then

(ii) performing additions and multiplications using the above-mentioned GF(2²) adders and multipliers to yield rₕ=(aₕ*bₗ+aₗ*bₕ+aₕ*bₕ) and rₗ=(aₗ*bₗ+aₕ*bₕ*μ); and then

(iii) transforming the tuple rₕ, rₗ back from a pair of GF(2²) elements to a single GF(2⁴) element (using the inverse of the above-mentioned isomorphism and implementations thereof).

It will be appreciated that it may not always be necessary to perform the above steps (i) and/or (iii). For example, the step (i) can be omitted if the input data is already in the form of tuples of elements of GF(2²) (e.g. from the step S500). Additionally, the step (iii) can be omitted if the output data is to be converted elsewhere back to a different field, (e.g. at the step S504). Additionally, the above steps (i) and (iii) may be omitted if two operations, implemented based on GF(2²) operators, are to be performed back-to-back. For example, if two of the above GF(2⁴) multiplication operators are to be implemented back-to-back (or a GF(2⁴) multiplication operator and a GF(2⁴) addition operator are to be implemented back-to-back), then the first one may omit the step (iii) and the second one may omit the step (i) (at least in respect of the output from the first operator).

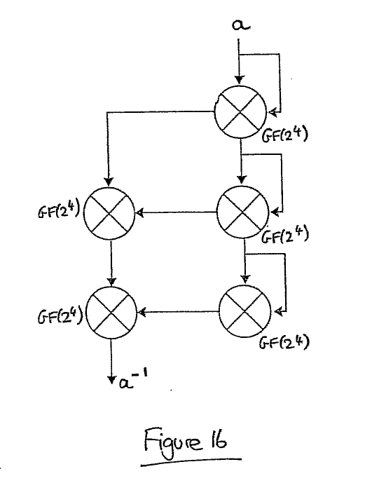

FIG. 15 schematically illustrates a logic circuit for performing GF(2⁴) multiplication using the GF(2²) adders of FIG. 7 and the GF(2²) multipliers of FIG. 9. As the above steps (i) and (iii) are optional, these have been omitted from FIG. 15.

It will be appreciated that multipliers in GF(2^{k}) (k=rs) can be implemented in analogous ways using GF(2^{r}) adders and multipliers as appropriate for a given irreducible polynomial over GF(2^{r}).

9.7) Inversion in GF(2⁴) and 1-of-4 GF(2⁴) Inverter

Fermat's little theorem provides that, for an element a of GF(2^{k}), a²^{^{k}}⁻¹=1 so that the inverse of the element a is then a²^{^{k}}⁻². In general, then, the inverse of the element a of GF(2^{k}), could be determined by a series of multiplications of powers of a, using GF(2^{k}) multipliers.

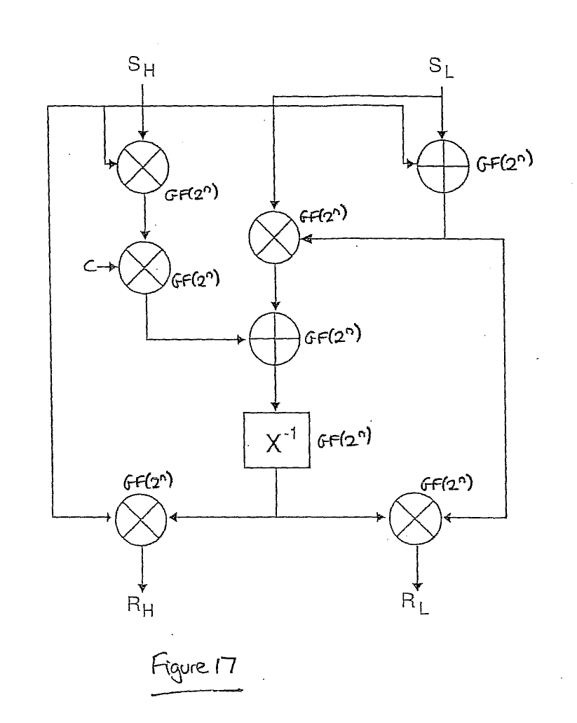

For the case of an element a of GF(2⁴), the inverse of a is the element a¹⁴. FIG. 16 schematically illustrates a logic circuit for performing GF(2⁴) inversion by calculating a¹⁴ using the GF(2⁴) multipliers of FIG. 15, which, as discussed above, can be implemented using GF(2²) adders and GF(2²) multipliers.

9.8) Inversion in GF(2⁸) and 1-of-4 GF(2⁸) Inverter

A GF(2⁸) inverter could be implemented using GF(2⁸) multipliers as discussed above using the approach based on Fermat's little theorem (see section 9.7). An alternative method of implementing GF(2⁸) inversion is given below, which is based on operations performed in GF(2⁴) using Euclid's algorithm.

In general it is well-known that for GF(2ⁿ), there always exists a polynomial P(x)=x²+x+with cεGF(2ⁿ) and P(x) primitive in GF(2ⁿ). From this primitive polynomial, the field GF((2ⁿ)²) can be constructed.

An element s of GF((2ⁿ)²) can be represented as S(x)=sₕx+sₗ where sₕ, sₗεGF(2ⁿ) under a suitable isomorphism (such as the ones provided above). Finding the inverse of S(x) is then equivalent to finding polynomials A(x) and B(x) in GF(2ⁿ)[x] such that A(x)P(x)+B(x)S(x)=1, in which case the inverse of s is B(x).

Then P(x)=Q(x)S(x)+R(x), where Q(x) and R(x) are the quotient and remainder respectively of dividing P(x) by S(x). It can be derived that Q(x)=sₕ⁻¹ x+(1+sₕ⁻¹sₗ)sₕ⁻¹ and R(x)=c+(1+sₕ⁻¹sₗ)sₕ⁻¹sₗ so that sₕ²P(x)=(sₕx+(sₕ+sₗ))S(x)+(csₕ²+sₕsₗ+sₗ²)

Setting θ=(csₕ²+sₕsₗ+sₗ²)⁻¹, we have:

θsₕ²P(x)=θ(sₕx+(sₕ+sₗ))S(x)+1

so that

θsₕ²P(x)+θ(sₕx+(sₕ+sₗ))S(x)=1

so that the inverse of S(x) is S⁻¹(x)=θ(sₕx+(sₕ+sₗ))=rₕx+rₗ.

Thus, the inverse of an element s of GF((2ⁿ)²) can be achieved by:

(i) transforming s to its respective representation sₕx+sₗ where sₕ, sₗεGF(2ⁿ) (using the above-mentioned isomorphism and implementations thereof, based on the primitive polynomial P(x)=x²+x+c, primitive over GF(2ⁿ)); then

(ii) determining the value of θ=(csₕ²+sₕsₗ+sₗ²)⁻¹ by calculating a GF(2ⁿ) inverse of csₕ²+sₕsₗ+sₗ²

(iii) performing additions and multiplications using the GF(2ⁿ) adders and multipliers to yield rₕ=θsₕ and rₗ=θ(sₕ+sₗ); and then

(iv) transforming the tuple rₕ, rₗ back from a pair of GF(2ⁿ) elements to a single GF((2ⁿ)²) element (using the inverse of the above-mentioned isomorphism and implementations thereof).

As discussed above with respect to the GF(2⁴) adders and multipliers, it will be appreciated (for the same reasons) that it may not always be necessary to perform the above steps (i) and/or (iv).

FIG. 17 schematically illustrates a logic circuit for performing GF((2ⁿ)²) inversion using the method described above, which involves GF(2ⁿ) adders and GF(2ⁿ) multipliers, as well as a GF(2ⁿ) inverter (which itself could be implemented by a similar logic circuit or could be implemented using the method described in section 9.7 above based on Fermat's little theorem). As the above steps (i) and (iv) are optional, these have been omitted from FIG. 17.

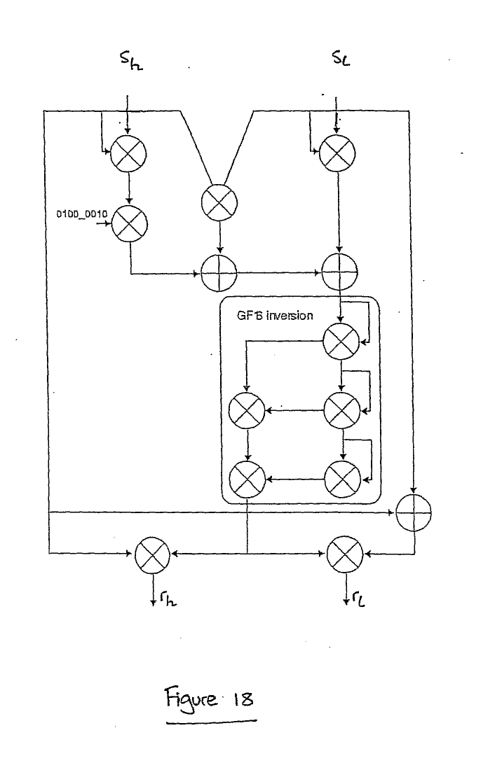

FIG. 18 schematically illustrates a specific application of the logic circuit of FIG. 17 (with a slightly different arrangement of adders and multipliers to achieve the same result) for performing GF(2⁸) inversion using the method described above, using the above-described GF(2⁴) adders and GF(2⁴) multipliers, as well as a GF(2⁴) inverter implemented using Fermat's little theorem. As the above steps (i) and (iv) are optional, these have been omitted from FIG. 18.

10) Further Example Operations on Data Represented in n-of-m Codewords

The following examples are further operations on data represented as 1-of-4 codewords. However, it will be appreciated that similar operations can be implemented analogously for general n-of-M representations of data.

### 10.1) Left Rotate

Consider a data word W having N bits, where N is even and at least 4. A 1-bit left rotation may be applied to the data word W, which involves moving the left-most bit of the data word W to the right-most position in the data word W. For example, if W=10001101, then a 1-bit left rotation of W yields the data word 00011011. In general, an s-bit left rotation of W involves moving the left-most s bits of the data word W to the right-most s bit positions in the data word W.

Since 1-of-4 codewords represent two data bits, when s is even, an s-bit left rotation simply involves swapping around the 1-of-4 codewords representing the data word W. This can be achieved simply by wire swapping. For example, a 1-of-4 representation of the data word W=10001101 is 0100, 0001, 1000, 0010. A 2-bit left rotation of W then simply yields the shifted order of codewords: 0001, 1000, 0010, 0100.

However, a 1-bit left rotation of a 1-of-4 encoded data word W requires further logic structures, as discussed below. Then, when s is odd and greater than 1, an s-bit left rotation can be implemented by performing a 1-bit left rotation and an (s−1)-bit left rotation (which simply involves wire swapping as described above, since s−1 will be even). These may be performed either way round.

For the 1-bit left rotation, an extraction operation is used. This extraction operation takes in an ordered pair of 1-of-4 codewords (b followed by a) which together represent four data bits, and outputs a 1-of-4 codeword representing the middle two data bits. For example, when the data bits are 1100, the 1-of-4 representations for these 4 data bits are b=1000 and a=0001 and the extraction process outputs the 1-of-4 codeword 0100 representing the middle two bits (10) of the data bits 1100.

A logical table for this extraction process is given in table 20 below.

TABLE 20

a = a₃a₂a₁a₀

| | | | | |
|---|---|---|---|---|
| Extract (b, a) | 0001 | 0010 | 0100 | 1000 |

| | | | | | |
|---|---|---|---|---|---|
| b = b₃b₂b₁b₀ | 0001 | 0001 | 0001 | 0010 | 0010 |
| | 0010 | 0100 | 0100 | 1000 | 1000 |
| | 0100 | 0001 | 0001 | 0010 | 0010 |
| | 1000 | 0100 | 0100 | 1000 | 1000 |

FIG. 27 schematically illustrates a power balanced logic circuit implementing the above-mentioned extract process for data represented using the 1-of-4 codewords. The output 1-of-4 codeword g=q₃q₂q₁q₀ may be derived from the following Boolean logic equations:

q₀=(a₀·b₀)+(a₀·b₁)+(a₂·b₀)+(a₂·b₁)=(a₀+a₂)·(b₀+b₁)

q₁=(a₀·b₂)+(a₀·b₃)+(a₂·b₂)+(a₂·b₃)=(a₀+a₂)·(b₂+b₃)

q₂=(a₁·b₀)+(a₁·b₁)+(a₃·b₀)+(a₃·b₁)=(a₁+a₃)·(b₀+b₁)

q₃=(a₁·b₂)+(a₁·b₃)+(a₃·b₂)+(a₃·b₃)=(a₁+a₃)·(b₂+b₃)

A 1-bit left rotation operation of data represented by N 1-of-4 codewords can then be achieved by using N extract operations. FIG. 28a schematically illustrates a power balanced logic circuit implementing a 1-bit left rotation operation on an input data word represented by four 1-of-4 codewords (x[15:12], x[11:8], x[7:4] and x[3:0]) to output a rotated data word represented by four 1-of-4 codewords (q[15:12], q[11:8], q[7:4] and q[3:0]). FIG. 28b schematically illustrates a power balanced logic circuit implementing a 1-bit left rotation operation on an input data word represented by sixteen 1-of-4 codewords (x[63:60], . . . , x[3:0]) to output a rotated data word represented by sixteen 1-of-4 codewords (q[63:60], . . . , q[3:0]).

### 10.2) Right Rotate

Consider a data word W having N bits, where N is even and at least 4. A 1-bit right rotation may be applied to the data word W, which involves moving the right-most bit of the data word W to the left-most position in the data word W. For example, if W=10001101, then a 1-bit right rotation of W yields the data word 11000110. In general, an s-bit right rotation of W involves moving the right-most bits of the data word W to the left-most s bit positions in the data word W.

The implementation of an s-bit right rotation is similar to the implementation of an s-bit left rotation. When s is even, wire swapping can be used to re-order the 1-of-4 codewords. When s is odd, the extract process illustrated in FIG. 27 is used. The difference between the left and right rotations lies in the inputs to the extract processes. This can be seen from a comparison of FIG. 29a and FIG. 28a, and a comparison of FIG. 29b and FIG. 28b.

A 1-bit right rotation operation of data represented by N1-of-4 codewords can then be achieved by using N extract operations. FIG. 29a schematically illustrates a power balanced logic circuit implementing a 1-bit right rotation operation on an input data word represented by four 1-of-4 codewords (x[15:12], x[11:8], x[7:4] and x[3:0]) to output a rotated data word represented by four 1-of-4 codewords (q[15:12], q[11:8], q[7:4] and q[3:0]). FIG. 29b schematically illustrates a power balanced logic circuit implementing a 1-bit-right rotation operation on an input data word represented by sixteen 1-of-4 codewords (x[63:60], . . . , x[3:0]) to output a rotated data word represented by sixteen 1-of-4 codewords (q[63:60], . . . , q[3:0]).

### 10.3) Shifting

An s-bit left shift operation can be implemented in a similar manner to an s-bit left rotation operation, except that the left-most s-bits are not moved to be the right-most s-bits. Instead, the right-most s-bits are set to be 0-bits.

Similarly, an s-bit right shift operation can be implemented in a similar manner to an s-bit right rotation operation, except that the right-most s-bits are not moved to be the left-most s-bits. Instead, the left-most s-bits are set to be 0-bits.

### 10.4) Comparators

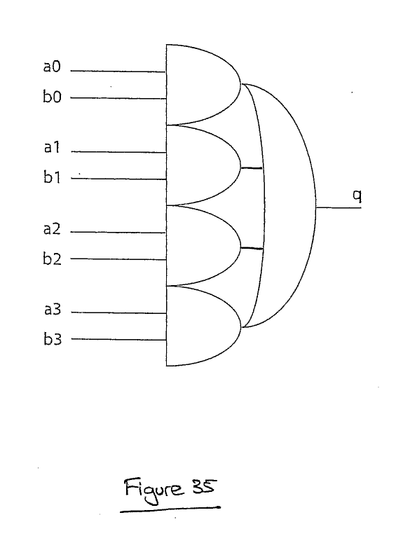

FIG. 35 schematically illustrates a 1-of-4 comparator, for comparing two 1-of-4 codewords a=a₃a₂a₁a₀ and b=b₃b₂b₁b₀ to yield an output bit q that assumes a value of 1 if a and b are the same, and a value of 0 otherwise.

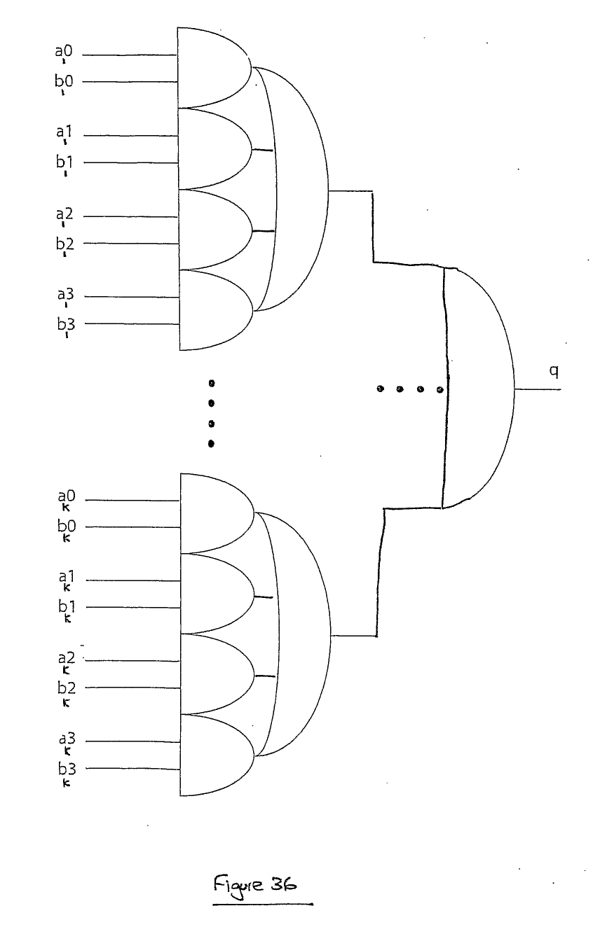

FIG. 36 schematically illustrates a wide 1-of-4 comparator, for comparing two data words a and b, each of which is composed of k 1-of-4 codewords. In particular, the data word a is composed of the 1-of-4 codewords a₁_{³}a₁_{²}a₁_{¹}a₁_{⁰} . . . aₖ_{³}aₖ_{²}aₖ_{¹}aₖ_{⁰}) and the data word b is composed of the 1-of-4 codewords b₁_{³}b₁_{²}b₁_{¹}b₁_{⁰} . . . bₖ_{⁰}bₖ_{²}bₖ_{¹}bₖ_{⁰}. The wide 1-of-4 comparator uses k lots of 1-of-4 comparators illustrated in FIG. 35. The output of the k comparators are fed to a k-input AND gate, which outputs a value of 0 if the data word a differs from the data word b, and a value of 1 otherwise.

### 10.5) Multiplexing

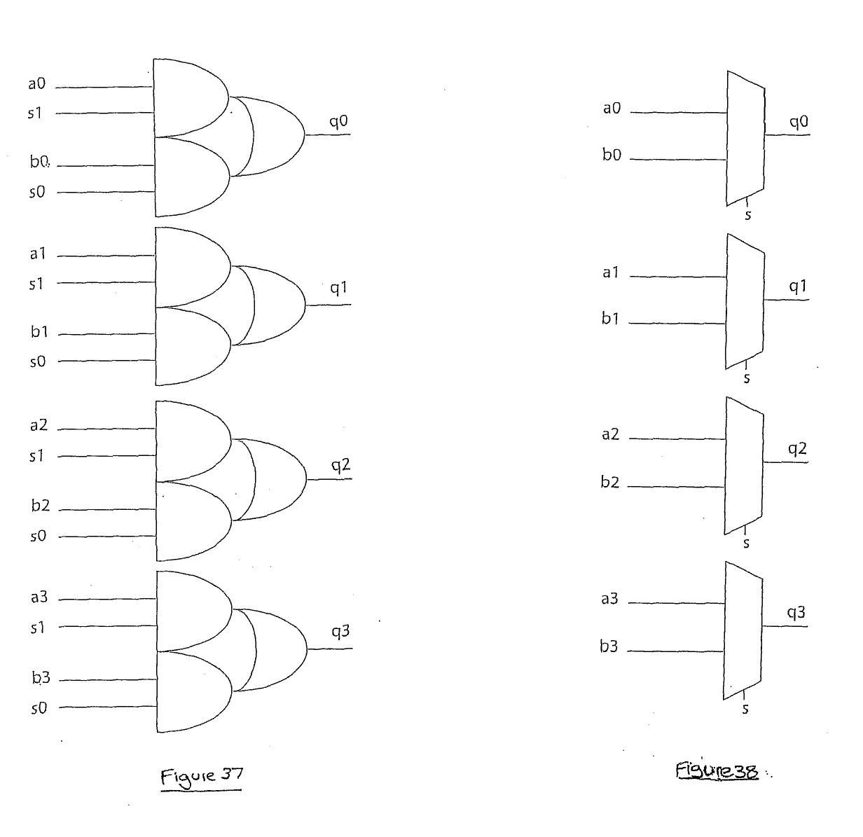

FIGS. 37 and 38 schematically illustrate two arrangements for multiplexing two 1-of-4 codewords a=a₃a₂a₁a₀ and b=b₃b₂b₁b₀ to yield an output 1-of-4 codeword q=q₃q₂q₁q₀. In FIG. 37, logic gates are used and, if a control bit s0 is set to be 1 and a control bit s1 is set to be 0, then q is set to be a, whilst if the control bit s0 is set to be 0 and the control bit s1 is set to be 1, then q is set to be b. FIG. 38 illustrates a similar operation, in which binary multiplexers are used and are controlled by a control signal s to determine which of a and b to store.

### 11) Example Application to AES128 Encryption

An example application of the above operations in GF(2^{k}), using the 1-of-4 representation, to implement AES128 encryption, decryption and key-expansion will be given below. It will be appreciated, though, that other cryptographic algorithms (such as AES192, AES256 and elliptic curve cryptography) could be implemented in similar ways using these, and other, operations in GF(2^{k}) and operating on data in the n-of-m representation.

As all of the logic structures used in this example embodiment are power balanced, this example implementation of AES128 is also power balanced.

As mentioned above, AES128 encryption operates on blocks of 128 bits of input binary data. It also uses a 128 bit secret key. This 128 bit secret key is used to generate eleven 128 bit sub-keys (key_0, key_1, . . . , key_10). These sub-keys may be pre-stored in the 1-of-4 format (for example within a smartcard) as tuples of elements of GF(2²).

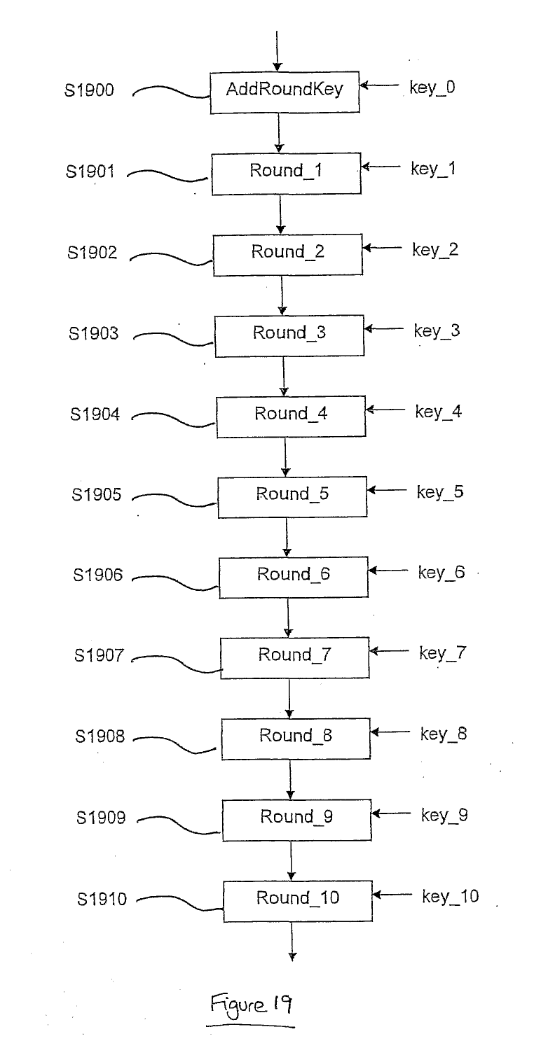

The processing performed, then, at the step S552 of FIG. 5b is schematically illustrated in FIG. 19. This uses numerous buses of width 256 bits, for example one to receive the 128-bit input data represented in the 1-of-4 format using 256 bits, and respective buses to receive the 128-bit sub-keys represented in the 1-of-4 format using 256 bits.

At a step S1900, an AddRoundKey operation is performed on the input 128 bits of plaintext data (represented as 256 bits of 1-of-4 codewords as elements of GF(2²)) using the sub-key key_0. The AddRoundKey operation will be described in more detail below with reference to FIG. 21.

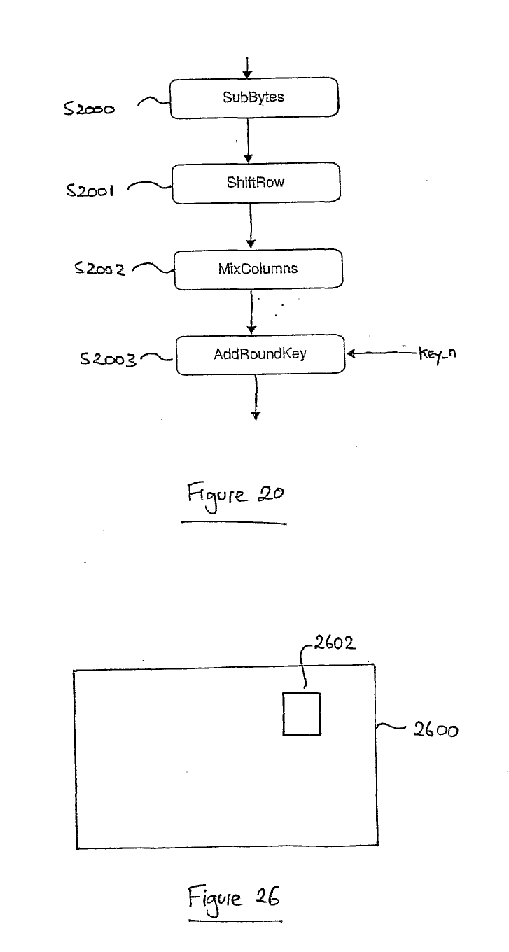

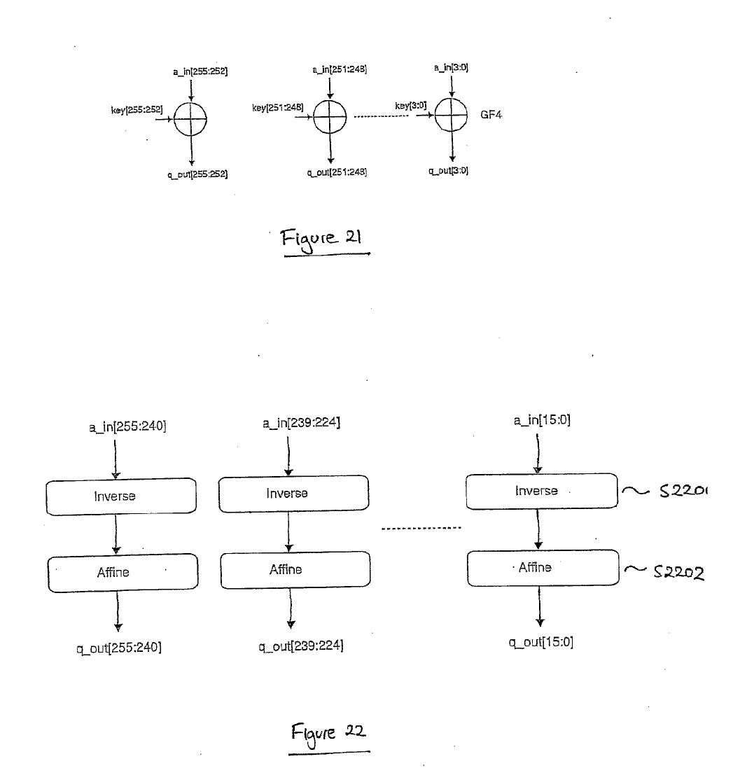

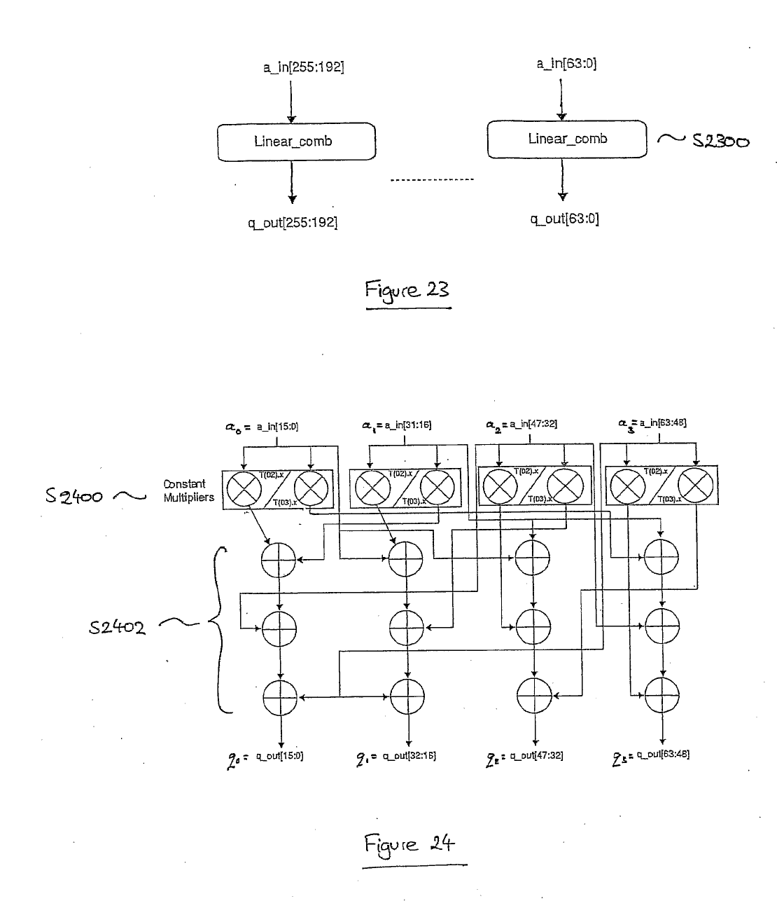

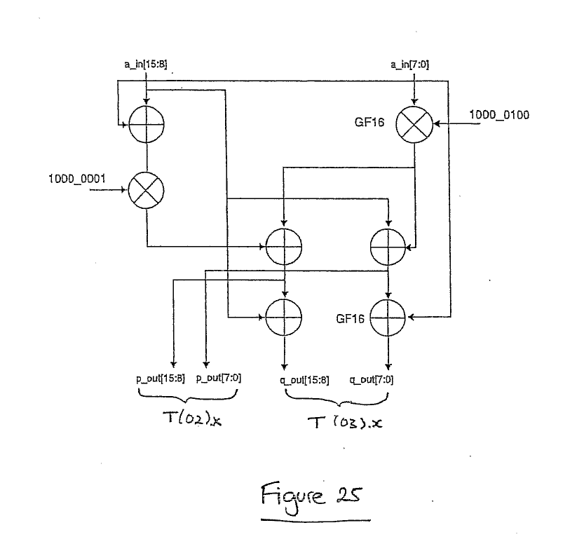

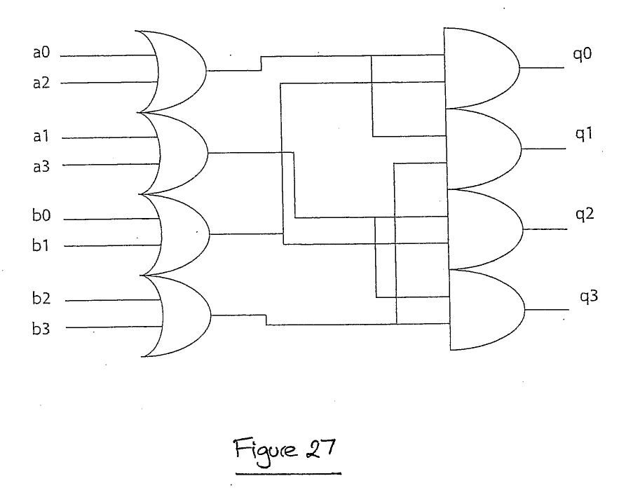

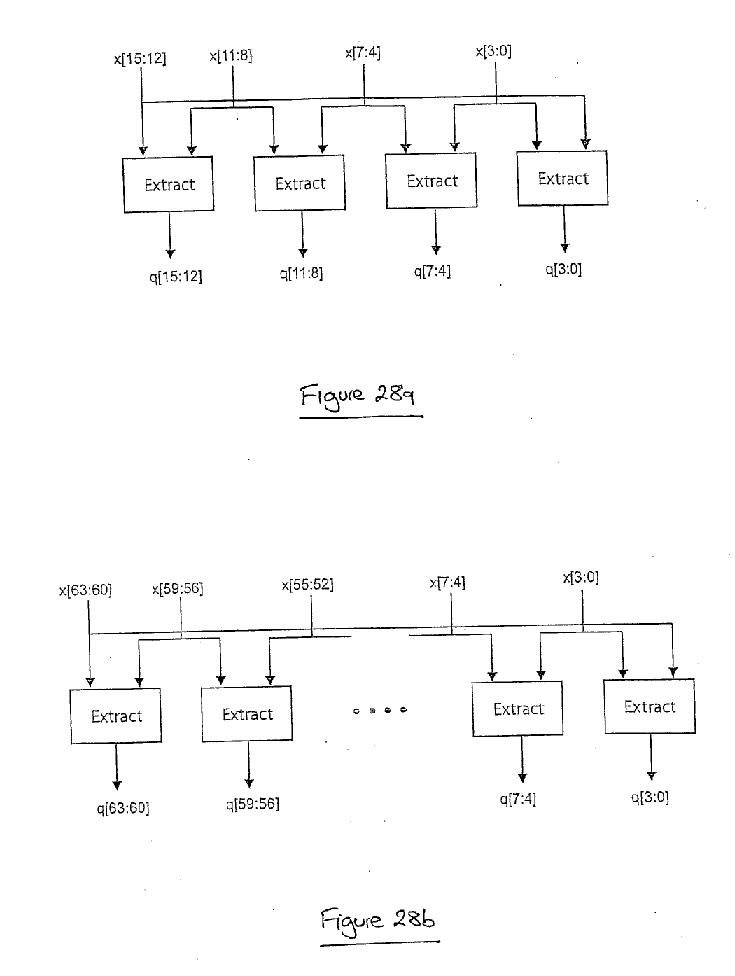

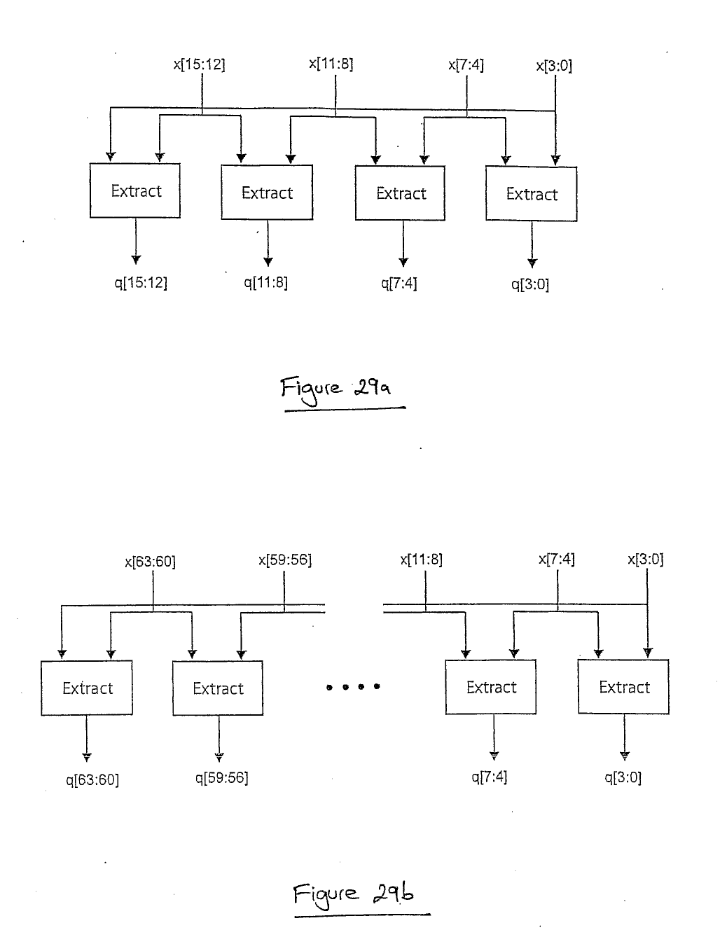

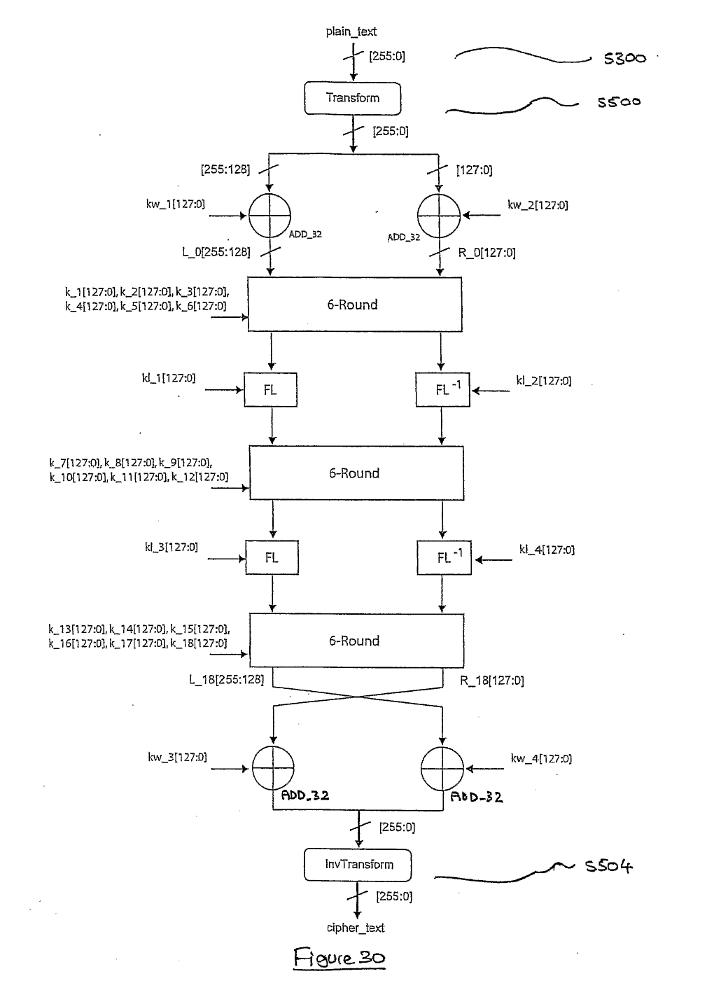

Then, at a step S1901, a Round_1 operation is performed on the output of the step S1900 using the sub-key key_1. The Round_1 operation will be described in more detail below with reference to FIG. 20.

Then, at a step S1902, a Round_2 operation is performed on the output of the step S1901 using the sub-key key_2. The Round_2 operation will be described in more detail below with reference to FIG. 20.

Then, at a step S1903, a Round_3 operation is performed on the output of the step S1902 using the sub-key key_3. The Round_3 operation will be described in more detail below with reference to FIG. 20.

Then, at a step S1904, a Round_4 operation is performed on the output of the step S1903 using the sub-key key_4. The Round_4 operation will be described in more detail below with reference to FIG. 20.

Then, at a step S1905, a Round_5 operation is performed on the output of the step S1904 using the sub-key key_5. The Round_5 operation will be described in more detail below with reference to FIG. 20.

Then, at a step S1906, a Round_6 operation is performed on the output of the step S1905 using the sub-key key_6. The Round_6 operation will be described in more detail below with reference to FIG. 20.

Then, at a step S1907, a Round_7 operation is performed on the output of the step S1906 using the sub-key key_7. The Round_7 operation will be described in more detail below with reference to FIG. 20.

Then, at a step S1908, a Round_8 operation is performed on the output of the step S1907 using the sub-key key_8. The Round_8 operation will be described in more detail below with reference to FIG. 20.

Then, at a step S1909, a Round_9 operation is performed on the output of the step S1908 using the sub-key key_9. The Round_9 operation will be described in more detail below with reference to FIG. 20.

Then, at a step S1910, a Round_10 operation is performed on the output of the step S1909 using the sub-key key_10. The Round_10 operation will be described in more detail below with reference to FIG. 20.

FIG. 20 schematically illustrates the processing performed for the Round_1, Round_2, . . . , Round_9 operations of FIG. 19.

At a step S2000, a SubBytes operation is performed on the data input to the Round_n operation. The SubBytes operation will be described in more detail below with reference to FIG. 22.

Then, at a step S2001, a ShiftRow operation is performed on the output of the step S2000. The ShiftRow operation will be described in more detail below.

Then, at a step S2002, a MixColumns operation is performed on the output of the step S2001. The MixColumns operation will be described in more detail below with reference to FIG. 23.

Then, at a step S2003, an AddRoundKey operation is performed on the output of the step S2002 using the relevant sub-key for this particular Round_n operation. The AddRoundKey operation will be described in more detail below with reference to FIG. 21.

The Round_10 operation is the same as the Round_1, . . . , Round_9 operations (but using key_10) except that the MixColumns operation, at the step S2002, is not performed for the Round_10 operation.

The AddRoundKey operation involves adding the 16 bytes of the data input to the AddRoundKey to the respective 16 bytes of the sub-key being used for the AddRoundKey operation. In other words, the AddRoundKey operation involves 16 GF(2⁸) addition operations. As discussed in section 9.5 above, each GF(2⁸) addition operation can be achieved by using four GF(2²) adders.

FIG. 21 schematically illustrates the AddRoundKey operation of FIG. 20, in which the input data a_in[255:0] represents elements of GF(2²) in the 1-of-4 format (i.e. 1-of-4 codewords a_in[255:252], . . . , a_in[3:0]) and the sub-key being used key[255:0] represents elements of GF(2²) in the 1-of-4 format (i.e. 1-of-4 codewords key[255:252], . . . , key[3:0]). The AddRoundKey operation is then performed using GF(2²) adders in parallel.

FIG. 22 schematically illustrates the SubBytes operation of FIG. 20, in which the input data a_in[255:0] represents elements of GF(2²) in the 1-of-4 format (i.e. 1-of-4 codewords a_in[255:252], . . . , a_in[3:0]). The input data is processed as separate bytes of data, i.e. as 4-tuples of elements of GF(2²) (i.e. a_in[255:240], . . . , a_in[15:0]).

At a step S2200, for each of the bytes (4-tuples of elements of GF(2²)), the inverse of the byte is determined. This can be implemented using the GF(2⁸) inversion logic structure schematically illustrated in FIG. 18.

Then, at a step S2202, each output byte (4-tuple of elements of GF(2²)) from the step S2000 undergoes an affine transformation. If the byte, considered to be an element a of GF(2⁸), that undergoes the affine transformation has a polynomial representation in GF(2⁸) of a=a₇x⁷+a₆x⁶+a₅x⁵+a₄x⁴+a₃x³+a₂x²+a₁x¹+a₀, then the output q of the affine transformation has a polynomial representation in GF(2⁸) of q=q₇x⁷+q₆x⁶+q₅x⁵+q₄x⁴+q₃x³+q₂x²+q₁x¹+q₀ where:

$$[ \begin{matrix}{q}_{0} \\ {q}_{1} \\ {q}_{2} \\ {q}_{3} \\ {q}_{4} \\ {q}_{5} \\ {q}_{6} \\ {q}_{7}\end{matrix} ] = [ \begin{matrix}1 & 0 & 0 & 0 & 1 & 1 & 1 & 1 \\ 1 & 1 & 0 & 0 & 0 & 1 & 1 & 1 \\ 1 & 1 & 1 & 0 & 0 & 0 & 1 & 1 \\ 1 & 1 & 1 & 1 & 0 & 0 & 0 & 1 \\ 1 & 1 & 1 & 1 & 1 & 0 & 0 & 0 \\ 0 & 1 & 1 & 1 & 1 & 1 & 0 & 0 \\ 0 & 0 & 1 & 1 & 1 & 1 & 1 & 0 \\ 0 & 0 & 0 & 1 & 1 & 1 & 1 & 1\end{matrix} ] [ \begin{matrix}{a}_{0} \\ {a}_{1} \\ {a}_{2} \\ {a}_{3} \\ {a}_{4} \\ {a}_{5} \\ {a}_{6} \\ {a}_{7}\end{matrix} ] + [ \begin{matrix}1 \\ 1 \\ 0 \\ 0 \\ 0 \\ 1 \\ 1 \\ 0\end{matrix} ]$$

As this is an operation on binary bits of data, equivalent to a set of Boolean equations, it can be implemented in a similar manner to that described at the end of section 4 above.

The ShiftRows operation requires no logic gates. Instead, the ShiftRows operation simply involves a permutation of the elements of GF(2⁸) (the bytes) being used to represent the data. Hence, the ShiftRows operation simply involves wiring the operation preceding the ShiftRows operation correctly to the operation after the ShiftRows operation.

FIG. 23 schematically illustrates the MixColumns operation of FIG. 20, in which the input data a_in[255:0] represents elements of GF(2²) in the 1-of-4 format (i.e. 1-of-4 codewords a_in[255:252], . . . , a_in[3:0]). The input data is processed as 4-tuples of bytes, i.e. as 16-tuples of elements of GF(2²) in the 1-of-4 format (a_in[255:192], . . . , a_in[63:0]).

At a step S2300, for each of the 4-tuples of bytes (16-tuples of elements of GF(2²)), a Linear_comb operation is performed.

FIG. 24 schematically illustrates the Linear_comb operation of FIG. 23, in which the input data a_in[63:0] represents elements of GF(2²) in the 1-of-4 format (i.e. 1-of-4 codewords a_in[63:60], . . . , a_in[3:0]). The input data is processed as separate bytes, i.e. as 4-tuples of elements of GF(2²) in the 1-of-4 format (i.e. a₃=a_in[63:48], . . . , a₀=a_in[15:0], where each aᵢ is represented by four 1-of-4 codewords).

At a step S2400, each of the bytes aᵢ undergoes multiplication by two constants to yield two output values each. This is illustrated in more detail with respect to FIG. 25 below.

Then, at a step S2402, the input bytes aᵢ and the constant-multiplier outputs are combined using GF(2⁸) adders.

The result of this Linear_comb operation is given by the equation below:

$$[ \begin{matrix}{q}_{0} \\ {q}_{1} \\ {q}_{2} \\ {q}_{3}\end{matrix} ] [ \begin{matrix}02 & 03 & 01 & 01 \\ 01 & 02 & 03 & 01 \\ 01 & 01 & 02 & 03 \\ 03 & 01 & 01 & 02\end{matrix} ] [ \begin{matrix}{a}_{0} \\ {a}_{1} \\ {a}_{2} \\ {a}_{3}\end{matrix} ]$$

where the output of the Linear-comb operation is the 4-tuple of elements of bytes q₃=q_out[63:48], . . . , q₀=q_out[15:0], each represented as a 4-tuple of elements of GF(2²) in the 1-of-4 format.

The inverse (decryption) of the AES128 encryption applies the inverse of the above-mentioned operations in reverse order.

The inverse of the AddRoundKey, InvAddRoundKey, is the same AddRoundKey.

Implementing the inverse of the ShiftRow operation, InvShiftRow, again involves no logic, but rather requires ensuring that the output of the operation preceding the InvShiftRow operation is wired correctly to the input of the operation following the InvShiftRow operation.

The inverse of the SubBytes operation, InvSubBytes, is implemented in a similar manner to that of the SubBytes operation. In particular, it is noted that the inverse of the Inverse operation at the step S2200 is simply the Inverse operation again. The inverse of the Affine transformation is a similar affine transformation which can be implemented in a similar manner.

The inverse of the MixColumns operation, InvMixColumns, is implemented in a similar manner to that of the MixColumns operation, albeit with different constant multipliers and different linear combinations of input elements.

As mentioned, some embodiments may be implemented so that the sub-keys key_0, . . . , key_10 are already available to the encryption/decryption processing. However, other embodiments make use of the actual key-expansion algorithm specified by the AES128 standard. This key-expansion algorithm makes use of (i) the SubBytes operation of FIG. 22 (ii) byte rotation and (iii) constant value addition. Hence the key-expansion could also be implemented analogously using operations based in GF(2²) using 1-of-4 codewords in a power balanced manner.

### 12) Example Application to Camellia-128 Encryption

Camellia is an 18 round Feistel block cipher encryption algorithm and supports 128-bit, 192-bit and 256-bit block sizes and keys. It may therefore use the same interface as the above-described AES algorithm. A full description of Camellia can be found at http://info.isl.ntt.co.jp/crypt/eng/camellia/index.html and at http://www.ipa.go.jp/security/rfc/RFC3713EN.html. It shall not be described in full detail herein, although the details relevant to a particular implementation of Camellia-128 according to an embodiment of the invention will be provided below.

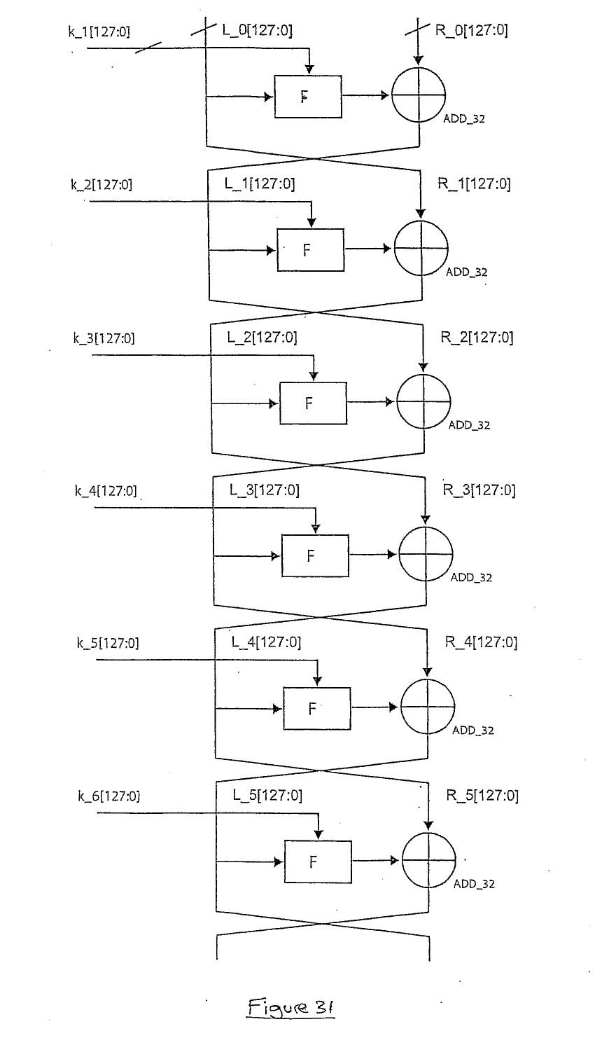

FIGS. 30-34 provide a schematic overview of the Camellia-128 algorithm (the 128-bit version of Camellia), using 1-of-4 operators.

FIG. 30 is a schematic overview of the Camellia-128 algorithm, in particular the processing performed at the step S302 of FIG. 3a. A block of plaintext comprises 128 bits, which is converted at the step S300 of FIG. 3a to 256 bits of 1-of-4 codewords. At the step S500 of FIG. 5a, each byte of plaintext (represented by four 1-of-4 codewords) is converted from an element of GF(2⁸) to a 4-tuple of elements of GF(2²), for example using the isomorphism described in section 3 above. This is similar to the processing performed at the step S550 of FIG. 5b. Each element of GF(2²) is represented as a 1-of-4 codeword.

In the figures, the various 64-bit round keys are assumed to be available, i.e. held in memory and supplied as required. They are stored in memory and supplied as 1-of-4 codewords. These round keys are shown in the figures as the keys kw_x[127:0] (x=1 . . . 4), kl_y[127:0] (y=1 . . . 4) and k_z[127:0] (z=1 . . . 18).

The data being processed is generally viewed as a 64-bit left half of the data and a 64-bit right half of the data. At the various rounds in the figures, the left half the data is represented by L_z (z=0 . . . 18) and the right half the data is represented by R_z (z=0 . . . 18).

Note that in these figures, the number in square brackets represents the bit-range for the 1-of-4 codewords, so that, for example, [127:0] represents 128 bits of 1-of-4 codeword data, which in turn represents 64 bits of actual data.

Camellia-128 has an 18 round Feistel structure with two FL/FL⁻¹ function layers after the 6th and 12th rounds. It also has 128-bit XOR operations with 128-bit round keys before the first and after the last round.

Before a data block is fed into the Feistel network it is separated into two 64-bit data blocks before the first round.

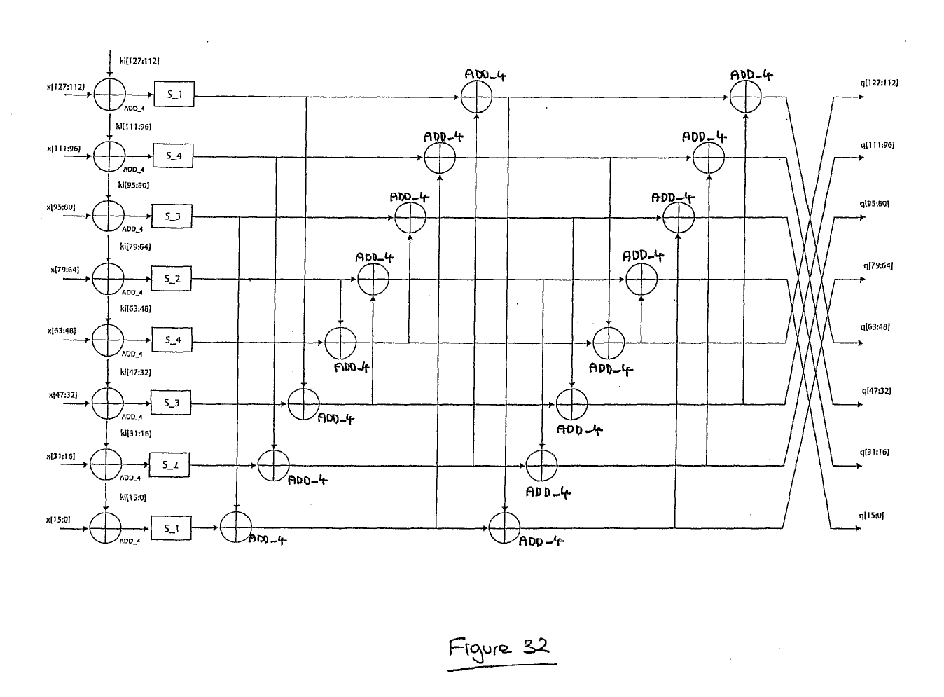

In the first round, the left half L_0[127:0] is processed by an F function together with a 64-bit round key k_1[127:0] and the output is XORed with the right half R_0[127:0]. At the end of the round the right and left half blocks are exchanged. This process forms one round. Processing for the other 17 rounds is analogous, using corresponding round keys. FIG. 31 schematically illustrates the processing for the first six rounds.

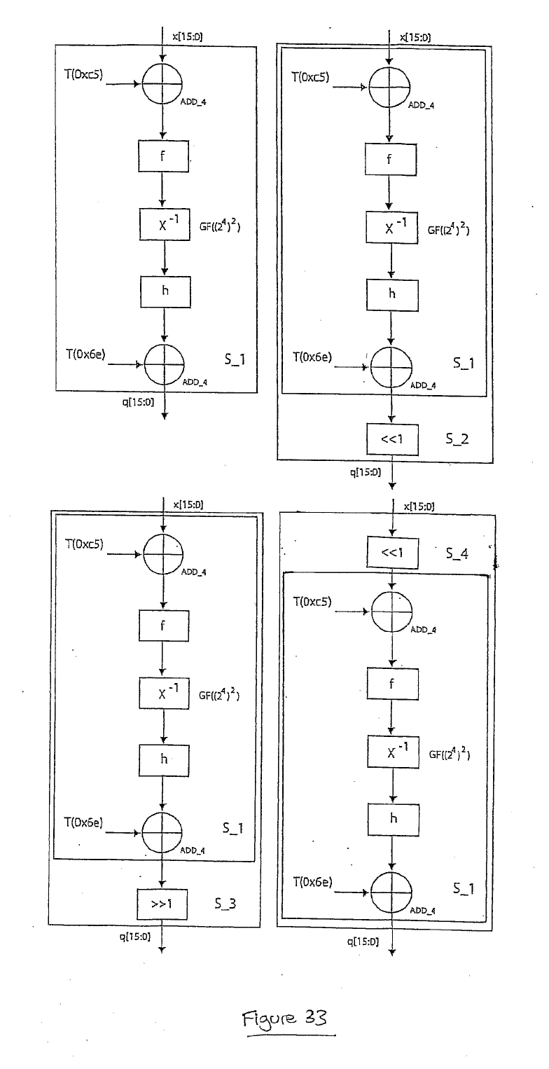

The F function is schematically illustrated in FIG. 32. In the F function, a 64-bit input block x[127:0] is XORed with a 64-bit round key k_i[127:0] and grouped into eight 8-bit data blocks, each of which is fed separately into a corresponding S-box. In Camellia, four types of S-boxes are used (S_1, S_2, S_3 and S_4) and each consists of a multiplicative inversion in GF(2⁸) and affine transformations defined as:

S1(x)=h(g(f⊕a)))⊕b

S2(x)=S1(x)<<1

S3(x)=S1(x)>>1

S4(x)=S1(x<<1)

where f and h are, linear mappings; g is the inverse operation in GF(2⁸); a is the 8-bit constant 0xc5 and b is the 8-bit constant 0x6e; and <<1 and >>1 and >>1-bit left and right rotations respectively.

The binary affine equations for the function f, mapping input a₈ . . . a₂a₁ as coefficients of a GF(2⁸) element to q₈ . . . q₂q₁ as coefficients of a GF(2⁸) element are:

q₁=a₆ [symbol] a₂

q₂=a₇ [symbol] a₃

q₃=a₈ [symbol] a₅ [symbol] a₃

q₄=a₈ [symbol] a₃

q₅=a₇ [symbol] a₄

q₆=a₅ [symbol] a₂

q₇=a₈ [symbol] a₁

q₈=a₆ [symbol] a₄

The binary affine equations for the function h, mapping input a₈ . . . a₂a₁ as coefficients of a GF(2⁸) element to q₈ . . . q₂q₁ as coefficients of a GF(2⁸) element are:

q₁=a₆ [symbol] a₅ [symbol] a₂

q₂=a₆ [symbol] a₂

q₃=a₇ [symbol] a₄

q₄=a₈ [symbol] a₂

q₅=a₇ [symbol] a₃

q₆=a₈ [symbol] a₁

q₇=a₅ [symbol] a₁

q₈=a₆ [symbol] a₃

The mappings f and h may be implemented in an analogous manner to the affine transformation at the step S2202 for the AES128 algorithm, whilst the function g (the inverse operation in GF(2⁸)) may be implemented as described in section 10.8 above.

FIG. 33 schematically illustrates the processing for each of the four S-boxes of Camellia-128.

In the F function, a linear 64-bit permutation using only XORing (P function) follows the non-linear substitution by the S-boxes.

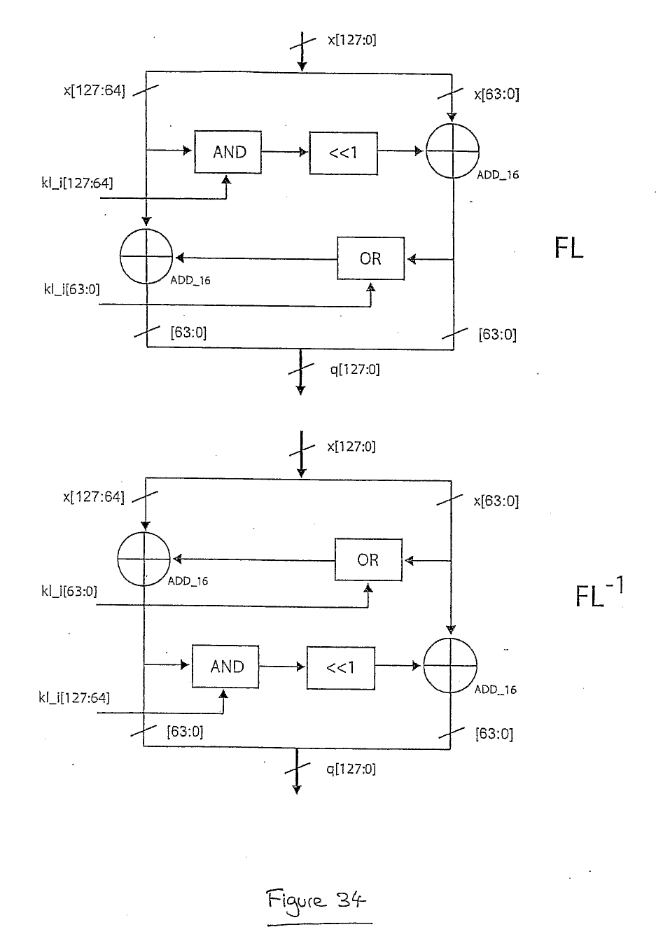

FIG. 34 schematically illustrates the FL and FL⁻¹ functions that are used after the 6th and 12th rounds. The FL and FL⁻¹ functions are built from logical operations: AND, OR, XOR and 1-bit rotations, which may each be implemented in an analogous manner to the logical and rotation operations described above.

The ADD_32 operations illustrated in FIGS. 30 and 31 (for the XOR operations) may be implemented as 32 GF(2²) adders (see section 10.5 above); the ADD_4 operations illustrated in FIGS. 32 and 33 (for the XOR operations) may be implemented as a four GF(2²) adders; and the ADD_16 operations illustrated in FIG. 34 may be implemented as 16 GF(2²) adders.

### 13) Asynchronous/Clockless/Event-Driven Circuits

As discussed above, embodiments of the invention may be implemented using synchronous circuits with a timing clock keeping the various processing steps in synchronisation. See, for example, FIGS. 4a-d.

Embodiments of the invention may make use of asynchronous circuits, which are event driven rather than being sequential and synchronised to a clock. For security applications, such asynchronous circuits have been shown to offer improved security. For example, the use of asynchronous circuits removes the use of a clock which may otherwise have been used by an attacker to synchronise attacks with the processing of the cryptographic system. Additionally, the use of asynchronous circuits improves the EMI signature of the cryptographic implementation, which could otherwise have been analysed in a similar manner to power consumption analysis to deduce information, such as secret keys.

In such asynchronous circuits, it is known to use Muller-C elements. These may be used in known ways: for example, AND gates in the above-described circuits may be replaced by a single Muller-C element. Similarly, other types of logic gates may be constructed from Muller-C elements, as is known in this field of technology. Completion detection in 1-of-4 encoding would then involve a four-input OR gate and a register would use four Muller-C elements.

### 14) Distribution of Code and Smart Card Applications

Embodiments of the invention do not require making specialist hardware/technology-dependent architecture designs for specific semiconductor devices (integrated circuits, FPGAs, etc.) to try to implement countermeasures against power analysis attacks. Instead, generic high-level code (computer program) to implement the above-mentioned logic structures can be used. This could be written, for example, in a hardware description language, such as Verilog or VHDL. This code can then be synthesised and mapped to specific target semiconductor technologies. For example, the code can be synthesised and mapped to a specific integrated circuit technology of a specific technology vendor, so that an integrated circuit can be produced that is configured to execute the above-mentioned methods and logic structures. Additionally, the code can be synthesised and mapped for a specific programmable device (e.g. an FPGA), so that the device can be programmed with the synthesised code so that it is configured to execute the above-mentioned methods and logic structures.

As such, the development work involved is greatly reduced as the same code can be used across all platforms/technologies—it only then has to be synthesised and mapped, as usual, for the target platform/technology. In this way, the same code to implement the above-mentioned logical structures can be developed and distributed to a wide range of producers of smartcards, integrated-circuit cards/devices and other embedded security devices. The recipients of the code then simply need to synthesise and map the code according to the target technology (integrated circuit, FPGA, etc.). Semiconductor devices (e.g. integrated circuits and programmed devices such as FPGAs) that incorporate an implementation of the cryptographic algorithm according to embodiments of the invention can then be generated.

FIG. 26 schematically illustrates a device 2600 (such as a smartcard, integrated circuit device, security device, semiconductor device, etc.) having a logic structure/processor 2602 configured to perform cryptographic processing according to an embodiment of the invention. The logic structure comprises the various logic gates to implement the above-mentioned logic circuits/structures for the cryptographic algorithm implementation. The hardware description language code for implementing the above-mentioned logic circuits/structures for the cryptographic algorithm has been synthesised for the particular technology being used for the device 2600 and the logic structure/processor 2602 is configured according to the synthesised code so that it can perform the cryptographic processing according to embodiments of the invention.

It will be appreciated that, insofar as embodiments of the invention are implemented by a computer program, then a storage medium and a transmission medium carrying the computer program form aspects of the invention.

1-29. (canceled)

30. A method comprising:
performing a cryptographic process on data, the cryptographic process treating a quantity of the data as an element of a Galois field GF(λ^{k}), where k=rs, the method comprising:
isomorphically mapping, via a computing device, the element of the Galois field GF(λ^{k}) to an s-tuple of elements of a Galois field GF(λ^{r}); and
representing and processing, via the computing device, each of the elements of the s-tuple of elements of the Galois field GF(λ^{r}) in the form of one or more respective n-of-m codewords, where an n-of-m codeword comprises n 1-bits and m-n 0-bits, where m and n are predetermined positive integers and n is less than m.

31. A method according to claim 30, comprising isomorphically mapping the processed s-tuple of elements of the Galois field GF(λ^{r}) to an element of the Galois field GF(λ^{k}).

32. A method according to claim 30, in which λ=2 or λ=3.

33. A method according to claim 30, in which λ=2, k=8, s=4 and r=2.

34. A method according to claim 30, in which the cryptographic process involves performing a Galois field GF(λ^{k}) operation involving an element of the Galois field GF(λ^{k}) corresponding to at least a part of the data, the method comprising:
performing the Galois field GF(λ^{k}) operation by performing one or more Galois field GF(λ^{r}) operations involving the s-tuple of elements of the Galois field GF(λ^{r}) corresponding to the element of the Galois field GF(λ^{k}) corresponding to the at least a part of the data.

35. A method according to claim 34, in which the Galois field GF(λ^{k}) operation comprises one or more of: GF(λ^{k}) addition, GF(λ^{k}) multiplication, GF(λ^{k}) subtraction, GF(λ^{k}) division, GF(λ^{k}) exponentiation, GF(λ^{k}) inversion, GF(λ^{k}) logarithm, and a GF(λ^{k}) logical operation.

36. A method according to claim 34, in which the Galois field GF(λ^{r}) operation comprises one or more of: GF(λ^{r}) addition, GF(λ^{r}) multiplication, GF(λ^{r}) subtraction, GF(λ^{r}) division, GF(λ^{r}) exponentiation, GF(λ^{r}) inversion, GF(λ^{r}) logarithm, and a GF(λ^{r}) logical operation.

37. A method according to claim 30, comprising:
receiving input data in a binary format; and
converting the input data from the binary format to one or more n-of-m codewords for processing.

38. A method according to claim 30 comprising:
converting the processed data represented as n-of-m codewords to a binary format; and
outputting the processed binary format data.

39. A method according to claim 30, in which processing a first n-of-m codeword and then processing a subsequent second n-of-m codeword comprises using a predetermined data value between the first n-of-m codeword and the second n-of-m codeword.

40. A method according to claim 39, in which the predetermined data value comprises m 0-bits or m 1-bits.

41. A method according to claim 30, in which processing an n-of-m codeword comprises:
converting the n-of-m codeword to one or more p-of-q codewords, where the pair (p,q) is different from the pair (n,m);
processing the one or more p-of-q codewords; and
converting the processed one or more p-of-q codewords to an n-of-m codeword.

42. A method according to claim 41, in which p=1 and q=2.

43. A method according to claim 30, in which n=1 and m=4.

44. A method according to claim 30, in which the cryptographic processes is one of:
an encryption process;
a decryption process;
a hashing process;
a digital signature process;
a key-exchange process; or
an authentication process.

45. A method according to claim 30, comprising detecting that an error has been introduced into the codewords being processed by checking that a data word being processed is represented as a n-of-m codeword.

46. An apparatus for performing a cryptographic process on data, the cryptographic process treating a quantity of the data as an element of a Galois field GF(λ^{k}), where k=rs, the apparatus comprising a logic processor arranged to:
isomorphically map the element of the Galois field GF(λ^{k}) to an s-tuple of elements of a Galois field GF(λ^{r}); and
represent and process each of the elements of the s-tuple of elements of the Galois field GF(λ^{r}) in the form of one or more respective n-of-m codewords, where an n-of-m codeword comprises n 1-bits and m-n 0-bits, where m and n are predetermined positive integers and n is less than m.

47. An apparatus according to claim 46 comprising one or more logic structures arranged together to perform the cryptographic process, at least one of the logic structures being a power balanced logic structure.

48. An apparatus according to claim 47, in which a power balanced logic structure is a logic circuit that comprises logic gates arranged such that the logic circuit consumes substantially the same amount of power for all possible combinations of valid inputs to the logic circuit.

49. An apparatus according to claim 47, in which one of the power balanced logic structures comprises one or more logic gates that consume power and output a predetermined logic value.

50. An apparatus according to claim 47, in which the apparatus is arranged to store predetermined data for use in the cryptographic process, the predetermined data being stored as one or more n-of-m codewords.

51. An apparatus according to claim 50, in which the predetermined data comprises one or more keys.

52. An apparatus according to claim 46, in which the apparatus is one of: an integrated-circuit device; a smartcard; or a security device.

53. A data carrying storage medium tangibly carrying a computer program which, when executed by a computer, carries out a method of performing a cryptographic process on data, the cryptographic process treating a quantity of the data as an element of a Galois field GF(λ^{k}), where k=rs, the method comprising:
isomorphically mapping the element of the Galois field GF(λ^{k}) to an s-tuple of elements of a Galois field GF(λ^{r}); and
representing and processing each of the elements of the s-tuple of elements of the Galois field GF(λ^{r}) in the form of one or more respective n-of-m codewords, where an n-of-m codeword comprises n 1-bits and m-n 0-bits, where m and n are predetermined positive integers and n is less than m.

54. A method of forming an apparatus for performing a cryptographic process on data, the method comprising:
receiving computer program code which, when executed by a computer, carries out a cryptographic method of performing a cryptographic process on data, the cryptographic process treating a quantity of the data as an element of a Galois field GF(λ^{k}), where k=rs, the cryptographic method comprising:
isomorphically mapping the element of the Galois field GF(λ^{k}) to an s-tuple of elements of a Galois field GF(λ^{r}); and
representing and processing each of the elements of the s-tuple of elements of the Galois field GF(λ^{r}) in the form of one or more respective n-of-m codewords, where an n-of-m codeword comprises n 1-bits and m-n 0-bits, where m and n are predetermined positive integers and n is less than m;
synthesising and mapping the computer program code to a target semiconductor technology, the apparatus using the target semiconductor technology; and
forming the apparatus from the synthesised and mapped computer program code.

55. The method of claim 54, in which the target semiconductor technology is an integrated circuit technology or a programmable device technology.
